(19) United States
(12) Patent Application Publication
(10) Pub. No.: US 2025/0387874 A1
(43) Pub. Date: Dec. 25, 2025

(54) DEVICES, SYSTEMS, AND METHODS FOR SKATE BLADE ALIGNMENT IN A SKATE SHARPENING SYSTEM

(71) Applicant: Velasa Sports, Inc., Acton, MA (US)

(72) Inventors: Joseph Patrick Tracy, Hutchinson, MN (US); Daniel A. Beaudet, Lexington, MA (US); Russell K. Layton, Jr., Acton, MA (US)

(21) Appl. No.: 18/879,656

(22) PCT Filed: Jun. 30, 2023
(86) PCT No.: PCT/US2023/069532

§ 371 Date: Dec. 27, 2024

Related U.S. Application Data
(60) Provisional application No. 63/367,562, filed on Jul. 1, 2022.

(51) Int. Cl. B24B 49/12; B24B 3/00; B24B 49/10

(52) U.S. Cl. CPC B24B 49/12; B24B 3/003; B24B 49/10

(57) ABSTRACT

An alignment system configured for use in a skate sharpening system (200) can comprise: a securing component (202) configured to secure a skate blade (100) within a skate sharpening system (200); an alignment component (600) positioned within a housing of the skate sharpening system (200); a control system configured to control operation of the skate sharpening system (200); and at least one measurement device (400) configured to perform at least one measurement of at least one of component of the skate sharpening system (200).

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit of U.S. Provisional Patent Application No. 63/367,562, filed Jul. 1, 2022, the entire contents of which are hereby incorporated by reference in its entirety.

### BACKGROUND

### Field

The present disclosure relates to the field of aligning skate blades in skate sharpening systems.

### Description of the Related Art

In the area of ice skating, whether it is hockey, figure skating or other, the blades used on the skates are a critical component in the performance of the skater/athlete. The blades are generally sharpened and profiled to exact specifications. These specifications will be determined based on many factors, including but not limited to the skater's height, weight, ability, role, ice conditions (e.g., temperature), etc. These exact specifications may be different for each skater and will be key factors in the performance yielded from the blades.

Because of the criticality of the exact sharpening specifications, skate sharpening machines typically have a calibration or alignment process performed prior to sharpening a skate blade. This usually involves the use of one of more devices being inserted into the skate sharpening machine to confirm alignment of the machine's critical components.

The skate blade sharpening industry is a large industry, with many technologies available for the sharpening of skates to precise specifications. However, there is a need for improved technologies to facilitate and/or execute accurate, precise and consistent adjustments to the sharpening or profiling machine to achieve the desired results.

### SUMMARY

The present disclosure relates to devices and methods which improve the current state of the art for aligning the grinding wheel to the skate blade.

Sharpening a skate blade involves creating a geometry between the edges of the skate blade across the thickness of the skate blade. Profiling or contouring a skate blade involves creating a shape from heel to toe along the length of the entire blade. In both a sharpening process as well as a profiling process, one common, important process control is ensuring that the centerline of the skate blade(s) is aligned with the centerline of the grinding wheel, or at a desired and known centerline offset.

Various systems, methods, and devices are disclosed for the adjustment of a grinding wheel to a skate blade. The systems, methods, and devices of the disclosure each have several innovative aspects, no single one of which is solely responsible for the desirable attributes disclosed herein.

In some embodiments, the systems, methods, and devices used for alignment can be used in a preliminary setup step with a manual adjustment prior to commencing a skate sharpening or profiling operation on a skate sharpening system. Some embodiments measure the skate directly and some measure intermediate jigs or fixtures.

In some embodiments, the systems, methods, and devices used for alignment can be used in a preliminary setup step with an automated adjustment prior to commencing a skate sharpening or profiling operation on a skate sharpening system. Some embodiments measure the skate directly and some measure intermediate jigs or fixtures.

In some embodiments, the systems, methods, and devices can be used in real time during a skate sharpening or profiling operation on a skate sharpening system.

There is a substantial need for an automated alignment, whether it is a setup step, in real-time during the grinding process, or both. In some embodiments, the methods, systems, and devices disclosed herein can be used to measure the blade centerline location along the entire length of the blade and adjust the skate blade and/or grinding wheel before sharpening to minimize uneven sharpening along the length of the blade.

The methods and devices disclosed herein may result in one or more of the following advantages over current alignment methods. One advantage may be removing the reliance on human vision for interpreting the alignment and/or adjustments. Another advantage may be removing or reducing the amount of human involvement in performing the actual adjustment (e.g., by manually turning an adjustment knob by hand). By using measurement devices/sensors such as, for example, imaging devices, lasers, and/or the like, in place of the human eye, the precision and accuracy of the determination of the amount of adjustment required may be improved and/or the amount of time required for alignment may be reduced. Similarly, by using automated motion systems such as, for example, motors, actuators, piezoelectric actuators, and/or the like, in place of the human adjustment, the automated devices and methods may improve the precision and accuracy of the mechanical adjustment as well as the reduce the amount of time required.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings. The accompanying drawings, which are incorporated in, and constitute a part of, this specification, illustrate embodiments of the disclosure. Embodiment of the present disclosure are illustrated by way of example, and not by way of limitation, in the figures of the accompanying drawings and in which like references indicate similar elements. According to common practice, the various features of the drawings discussed below are not necessarily drawn to scale. The drawings are provided to illustrate example embodiments described herein and are not intended to limit the scope of the disclosure.

FIG. 1A illustrates an example schematic side profile of a skate blade;

FIG. 1B illustrates a perspective view of a skate blade with a magnified view of a hollow in the bottom portion of the skate blade;

FIG. 1C illustrates an example schematic section view of the back of the skate blade;

FIG. 1D illustrates an example schematic section view of the back of the six skate blades;

FIG. 2A illustrates a side schematic view of a skate blade and a grinding wheel;

FIG. 2B illustrates a sharpening of a skate blade when the grinding wheel is centered on the width of the skate blade;

FIG. 2C illustrates a sharpening of a skate blade when the grinding wheel is not centered on the width of the skate blade;

FIG. 2D illustrates an example schematic views of skate blades with even edges and uneven edges;

FIGS. 3A illustrates a perspective view of an embodiment of a skate sharpening machine interacting with a skate;

FIG. 3B illustrates a top view of the skate sharpening machine of FIG. 3A interacting with a skate blade;

FIG. 3C illustrates a perspective close up view of the skate blade in skate sharpening machine of FIG. 3A;

FIG. 3D illustrates an exploded view of an optical alignment tool;

FIG. 3E illustrates a close up view of the optical alignment tool of FIG. 3D in the skate sharpening machine of FIG. 3A;

FIG. 3F illustrates a close up view of the optical alignment tool of FIG. 3D and a calibration wheel;

FIG. 3G illustrates a close up top view of the optical alignment tool of FIG. 3D in the skate sharpening machine of FIG. 3A;

FIGS. 4A illustrates a schematic side view of a spherical lens;

FIGS. 4B illustrates a schematic side view of an aspherical lens;

FIGS. 5A illustrates a schematic diagram of an optic measurement system;

FIG. 5B illustrates a schematic diagram of an optic measurement system with a beam splitter;

FIG. 6A illustrates a front perspective view of an embodiment of a measurement device;

FIG. 6B illustrates a front view of the measurement device of FIG. 6A;

FIG. 6C illustrates a back view of the measurement device of FIG. 6A;

FIG. 6D illustrates a left side view of the measurement device of FIG. 6A;

FIG. 6E illustrates a right side view of the measurement device of FIG. 6A;

FIG. 6F illustrates a top view of the measurement device of FIG. 6A;

FIG. 6G illustrates a bottom view of the measurement device of FIG. 6A;

FIG. 6H illustrates a front view of the measurement device of FIG. 6A with select components removed;

FIG. 7A illustrates a perspective view of an internal frame of the measurement device of FIG. 6A;

FIG. 7B illustrates a bottom view of the internal frame of FIG. 7A;

FIG. 8A illustrates a front view of a calibration wheel;

FIG. 8B shows a side view of the calibration wheel of FIG. 8A;

FIG. 9A illustrates a schematic diagram of an optic measurement system and a calibration wheel as a first position;

FIG. 9B illustrates a schematic diagram of an optic measurement system and a calibration wheel as a second position;

FIG. 10A illustrates a method of measuring the alignment of a skate sharpening machine using the measurement device of FIG. 6A and the calibration wheel of FIG. 8A:

FIG. 10B illustrates a method of recalibrating the measurement device of FIG. 6A;

FIG. 11A illustrates a first user interface being presented on a user device;

FIG. 11B illustrates a second user interface being presented on a user device;

FIG. 11C illustrates a third user interface being presented on a user device;

FIG. 12 illustrates an embodiment of a computing system which may implement example embodiments of one or more components of the measurement device and/or affiliated systems; and

FIG. 13A-13G illustrates various positional sensor systems that can be include in a skate sharping machine.

### DETAILED DESCRIPTION OF SOME EMBODIMENTS

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” or “another embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

### A. Overview

a. Skate Blade

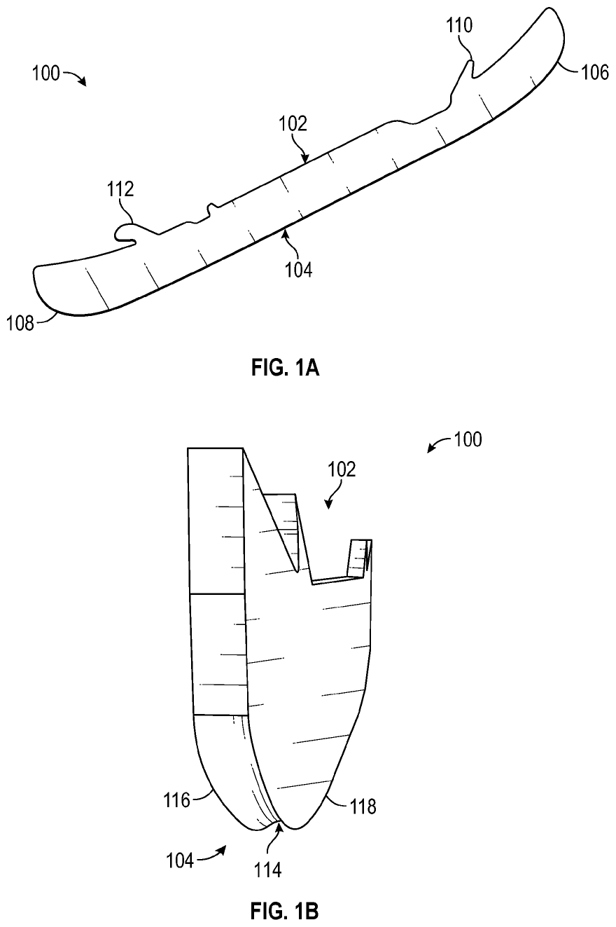

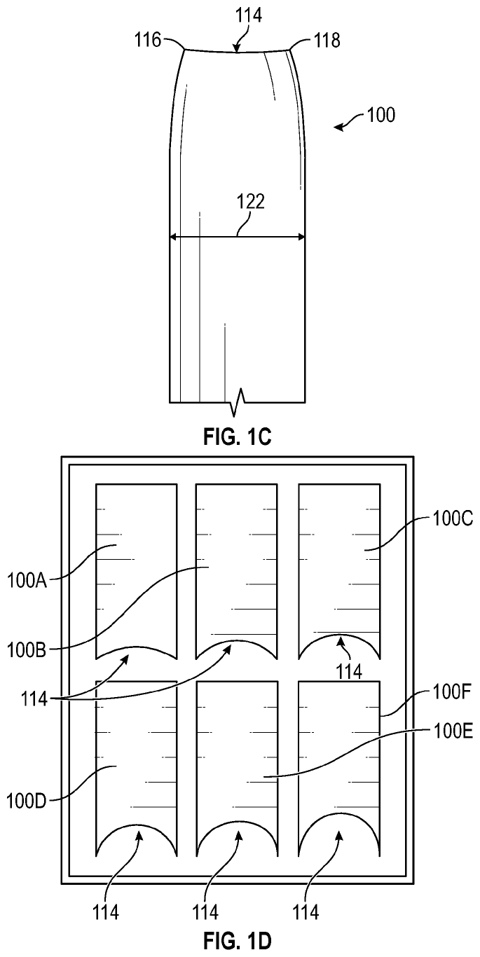

FIGS. 1A-1D illustrate different views and components of a skate blade 100. FIGS. 1A-1D are provided for illustrative purposes only. FIG. 1A illustrates an example schematic side profile of the skate blade 100. The skate blade 100 comprises a top potion 102, a bottom portion 104, a front portion/toe 106, a back portion/heel 108. The top potion 102 comprises a toe hook 110 and a heel hook 112. The toe hook 110 and the heel hook 112 are configured to be inserted into the toe and heel of a skate boot respectively. Generally, the skate blade 100 is removable from the skate boot. For example, the skate blade 100 may be removed from the skate boot prior to being sharpened. As shown in FIG. 1C, the skate blade 100 has a blade thickness 122.

FIG. 1B illustrates a perspective view of the skate blade 100 with a magnified view of a hollow 114 in the bottom portion 104. The hollow 114 may also be referred to as a Radius of Hollow 114 or a ROH 114. The hollow 114 extends along the length of the bottom portion 104 between the toe 106 and the heel 108. The hollow 114 comprises two edges, an inside edge 116 and an outside edge 118. For example, the hollow 114 may be considered a groove between the edges 116, 118. In use, the edges 116, 118 of the skate blade 100 contact the ice, allowing the user to skate across the ice.

FIG. 1C illustrates an example schematic section view of the back of the skate blade 100. As shown in FIG. 1C, the hollow 114 between edges 116, 118 of the skate blade 100 has a small radius, which may be a result of use of the skate blade 100. As the skate blade 100 is continually used, the edges 116, 118 wear down over time or become damaged, effectively compromising the radius of the hollow 114. A skate blade 100 with overused or damaged edges and minimal hollow 114 does not perform as well as a properly sharpened skate blade.

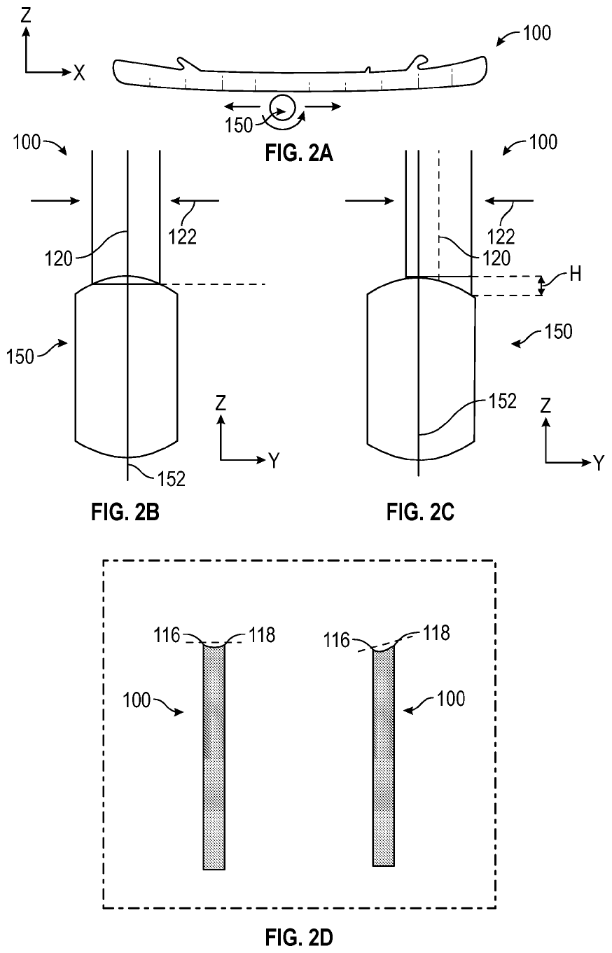

FIG. 1D illustrates an example schematic section view of the back of the six skate blades 100A-100F. Each skate blade 100 in FIG. 1D includes a hollow 114 with a different radius. As explained with reference to FIG. 2A, a grinding wheel can be used to grind a plurality of different radius size hollows 114 into the bottom portion 104 of the skate blades 100. Blade 100A comprises a hollow 114 of 1 inch, blade 100B comprises a hollow 114 of ¾ of an inch, blade 100C comprises a hollow 114 of ⅝ of an inch, blade 100D comprises a hollow 114 of ½ of an inch, blade 100E comprises a hollow of 7/16 of an inch, and blade 100F comprises a hollow of ⅜ of an inch. Generally, a smaller radius size of the hollow 114 allows the skate blade to bite into the ice better, which may allow a skater to have tighter turns and quicker acceleration. However, because the edges 116, 118 are digging deeper into the ice, there is greater friction between the skate blade 100 and the ice, which may result in a loss of glide speed. Generally, skaters select a specific radius size for the hollow 114 for their specific needs, which may depend on their skating type, use of the skate (e.g., for figure skating, hockey, etc.), player weight, skating style preferences (e.g., fast feet/tight turns or speed/long strides), and/or the like.

b. Grinding Wheel Skate Blade Relationship

FIG. 2A illustrates a side schematic view of the skate blade 100 and a grinding wheel 150. Generally, skate sharpening devices include an abrasive/grinding wheel 150 that can be used to contact the skate blade 100 to grind the radius of hollow 114 into the skate blade 100. In order to create the hollow 114, or reduce/enlarged the radius of the hollow 114, the grinding wheel 150 rotates in the plane of the skate blade 100 and contacts the bottom portion 104 of the skate blade 100 where blade material is to be removed. The grinding wheel 150 may also translate across the length of the skate blade 100 (e.g., from left to right and right to left in FIG. 2A), either by automated or manual means.

Throughout this disclosure, reference to the orientation of various components may be made to a consistent coordinate system defined by a skate sharpening system. In the coordinate system, the x-axis defines the path of the grinding wheel 150 in the skate sharpening system. As such, when the skate blade 100 is positioned in a skate sharpening system, the length of the skate blade 100 is aligned along the x-axis (e.g., as shown in FIG. 2A). The z-axis defines the vertical. The y-axis defines the linear position of the grinding wheel 150 that can be adjusted to align the grinding wheel 150 with the skate blade 100 (e.g., as shown in FIGS. 2B and 2C).

In skate sharpening, one of the critical parameters that affects the quality of the sharpening is the ability to accurately grind the hollow 114 (or any other shape) into the bottom portion 104 of the skate blade 100 that is nominally centered on the width W of the blade. Grinding the hollow 114 in an accurate manner to produce even edges 116, 118 is made difficult by the production tolerances of the components that make up the sharpening machine. An assembly of mechanical parts will generally be inaccurate to the desired nominal dimensions due to the inherent inaccuracy of the production/fabrication methods used. Consequently, the stack-up of the inaccuracies in the parts will cause the edges 116, 118 of the sharpened skate blade 100 to be imperfect. Even if a sharpening system is built to autocorrect for these inaccuracies, there may still be imperfections in those autocorrect or auto-alignment systems. If the hollow 114 being ground into the skate blade 100 is meant to be centered but is instead ground off center, due to, for example, the aforementioned inaccuracies, one edge 116/118 will be ground to a different height than the other edge 116/118. This condition will make it difficult to skate effectively even for the most elite skater.

FIGS. 2B and 2C illustrate front schematic views of the skate blade 100 and grinding wheel 150. The skate blade 100 has a central axis 120 that extends along the length of the skate blade 100 and is at the center of the width W and the blade thickness 122. Similarly, the grinding wheel 150 has a central axis 152. FIG. 2B illustrates a sharpening of the skate blade 100 when the grinding wheel 150 is centered on the width W of the skate blade 100. That is, the central axis 152 of the grinding wheel 150 is aligned with the central axis 120 of the skate blade 100. When the grinding wheel 150 and the skate blade 100 are aligned in this manner, the sharpening process results in the skate blade 100 having even edges 116, 118. For most skaters, even edges 116, 118 is desirable and may be considered a successful sharpening. For further clarity, edges 116, 118 are considered “even” when the delta height H between the edges 116, 118 is zero, substantially zero, or within an acceptable tolerance. For example, an acceptable tolerance may be a delta height H of less than 2 thou (0.002 inches).

FIG. 2C illustrates a sharpening of the skate blade 100 when the grinding wheel 150 is not centered on the width W of the blade. That is, the central axis 152 of the grinding wheel 150 in not aligned with the central axis 120 of the skate blade 100. When the grinding wheel 150 and the skate blade 100 are misaligned or offset in this manner, the sharpening process results in the skate blade 100 having uneven edges 116, 118. As noted above, the difference in height between the inside edge 116 and the outside edge 118 is referred to as the delta height H. For most skaters, uneven edges 116, 118 is not desirable and may be considered an unsuccessful sharpening. An unsuccessful sharpening may result from the delta height H being greater than the acceptable tolerance, for example, greater than 0.002 inches or 2 thou. It is recognized that the acceptable tolerance can vary between different skate sharpeners (e.g., the people operating the machine), different skaters, different skating coaches, and different skate sharpening machines, and the ranges provided for the acceptable tolerance are for example only. The acceptable tolerance can be referred to as the skate sharpening accuracy threshold or sharpening threshold for short.

FIG. 2D illustrates an example front schematic view of the skate blade 100 with an acceptable sharpening result (e.g., even edges 116, 118 where the delta height H is at or below a sharpening threshold) on the left, and an example front schematic view of the skate blade 100 with an unacceptable sharpening result (e.g., uneven edges 116, 118 where the delta height H exceeds a sharpening threshold) on the right.

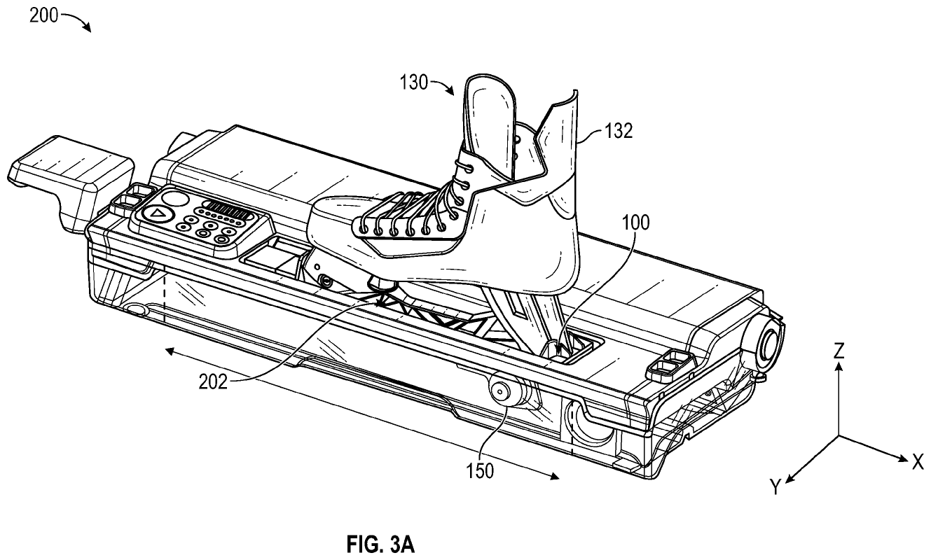

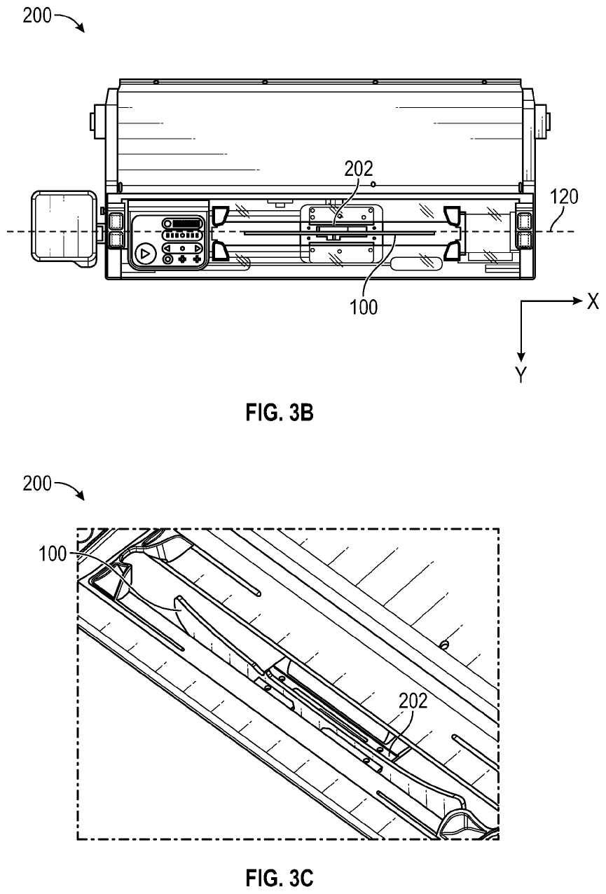

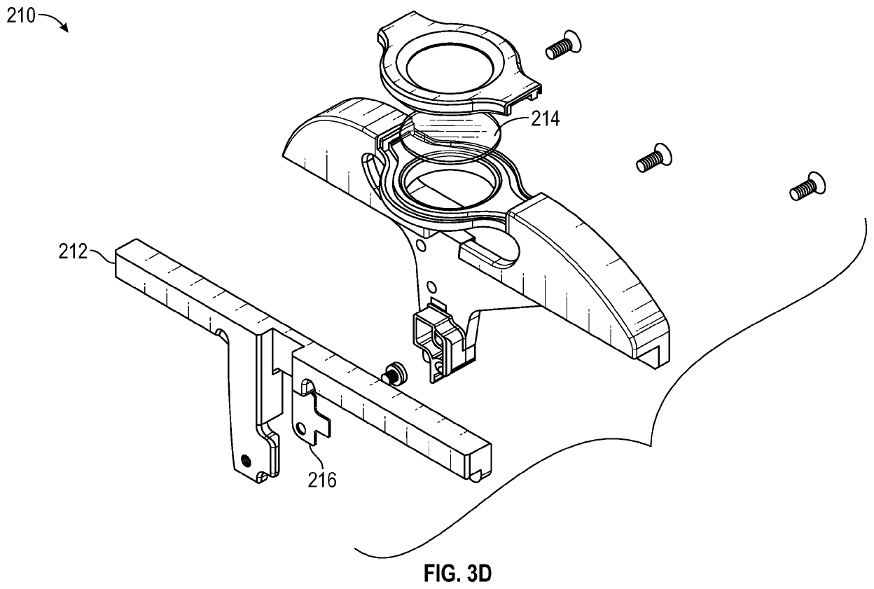

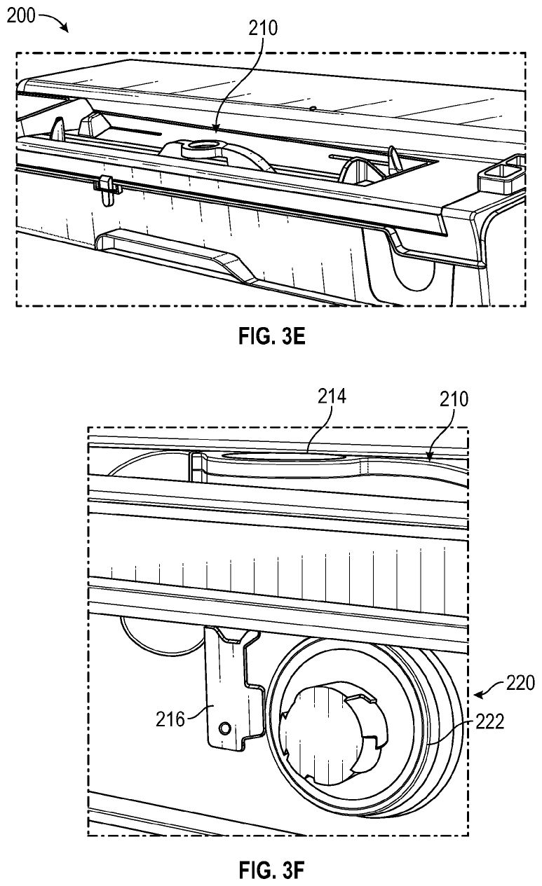

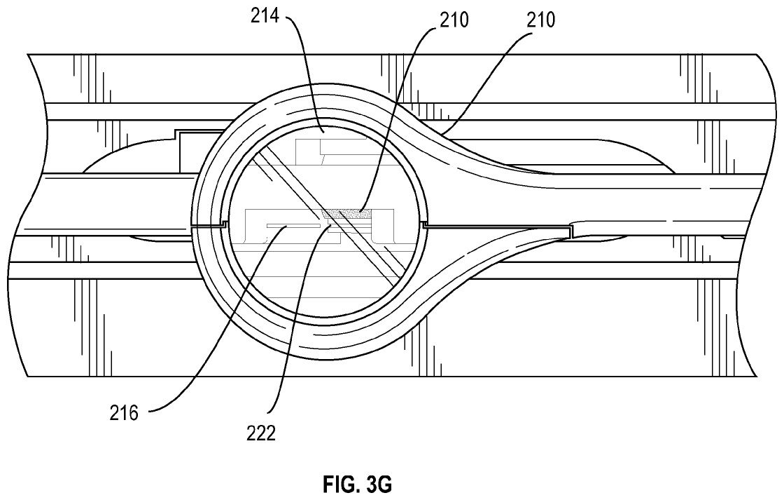

FIGS. 3A illustrates a skate sharpening machine 200 (also referred to herein as the skate sharpening device 200 or the sharpener 200) and a skate 130. The sharpener 200 includes a clamp or jaws 202 (shown more clearly in FIG. 3B) and the grinding wheel 150. The jaws 202 act as a securing component of the sharpener 200 to secure the skate blade 100 of the skate 130 and the grinding wheel 150 translates along the x-axis to sharpen the skate blade 100. As noted above, the linear position of the grinding wheel 150 along the y-axis can be changed to align the grinding wheel 150 with the skate blade 100. The skate 130 includes a boot portion 132 and the skate blade 100. The sharpener 200 can sharpen the skate blade 100 while attached to the boot portion 132 or while the skate blade 100 is detached from the boot portion 132. As shown, the skate 130 is positioned within the sharpener 200 such that the skate blade 100 can be sharpen.

Automated and semi-automated skate sharpeners 200 generally require one or more setup steps that include adjusting the position of the grinding wheel 150 relative to the skate blade 100. The position of the grinding wheel 150 relative to the skate blade 100 is a critical parameter in the sharpening process. When the central axis 152 of the grinding wheel 150 is not centered on the central axis 120 of the skate blade 100, as shown in FIG. 2C, the sharpening process will typically result in the skate 100 having uneven edges 116, 118. For example, in FIG. 2D, the left skate blade 100 has even edges 116, 118 while the right skate blade 100 has uneven edges 116, 118. Uneven edges 116, 118 can make the skate 130 extremely difficult to skate on, even for the most elite players, because the amount of grip that is produced on the inside and outside edges 116, 118 of the skate blade 100 are different and can provide an unpredictable and unnatural feel for the skater. However, there are some applications where a player may choose to intentionally offset the centerline for performance reasons, as discussed further herein.

FIG. 3B illustrates a top view of the sharpener 200 and the skate blade 100 (detached from the boot portion 132). FIG. 3C illustrates a perspective view of the skate blade 100 secured within the jaws 202. FIG. 3D illustrates an exploded view of an optical alignment tool 210. FIG. 3E illustrates the optical alignment tool 210 secured to the sharpener 200. FIG. 3F illustrates a calibration wheel 220 secured to the sharpener 200. The combination of the jaws 202, the optical alignment tool 210, and the calibration wheel 220 represent the current state of the art in aligning the central axis 120 of the skate blade 100 with the central axis 152 of the grinding wheel 150. The jaws 202 are configured to secure and position the central axis 120 of the skate blade 100 in the path of the grinding wheel 150 along the x-axis. The optical alignment tool 210 includes a jaw mount 212, a lens 214, and an alignment tab 216. A user can secure and position the jaw mount 212 in the jaws 202 and use the lens 214 to view the alignment tab 216 and the grinding wheel 150 or the calibration wheel 220 in the sharpener 200. The calibration wheel 220 includes an alignment channel 222. The alignment channel 222 may be a line or indented portion of the calibration wheel 220 that represents the central axis 152 of the grinding wheel 150.

The setup step of manually adjusting the position of the grinding wheel 150 relative to the skate blade 100 can be tedious, time consuming, inaccurate, and imprecise. In one example of an automated skate sharpener, with reference to FIG. 3G, which illustrates the optical alignment tool 210 secured to the jaws 202 of the sharpener 200, in operation, the user can replace the grinding wheel 150 with the calibration wheel 220. The user can then secure the optical alignment tool 210 to the jaws 202 such that both the alignment tab 216 and the calibration wheel 220 are visible through the lens 214. Relying solely on their own vision, the user can manually adjust the location of the calibration wheel 220 until the alignment channel 222 is aligned with the alignment tab 216. Once the user is satisfied with their alignment, the user can replace the calibration wheel 220 with the grinding wheel 150, insert the skate blade 100 into the jaws 202 of the sharpener 200, and proceed with the sharpening operation.

The manual alignment of calibration wheel 220 using the optical alignment tool 210 is a subjective process and may result in inaccurate or inconsistent alignment between different users. When the calibration wheel 220 is not aligned with the alignment tab 216 of the optical alignment tool 210, generally, the sharpening operation produces un-acceptable results, such as the uneven edges 116, 118 of the skate blade 100 shown in the right side image of FIG. 2D.

There are several limitations of the current state of the art for aligning the central axes of skate blades and grinding wheels (i.e., by optical alignment tool 210 and calibration wheel 220). One limitation of using the sharpener optical alignment tool 210 is the resolution of the measurement. The optical alignment method relies on the user to visually look at the position of the alignment tab 216 relative to the alignment channel 222 of the calibration wheel 220. As a result, the measurement process is limited to what the human eye can detect in addition to being a subjective process that varies between different users. Further, there is a finite difference in alignment that the user can detect. On account of these limitations, use of the optical alignment tool 210 and calibration wheel 220 can result in a skate blade having a delta height H, the edge to edge height difference, that is outside of an acceptable tolerance range (e.g., a sharpening threshold).

With the optical alignment tool 210, a user may attempt to use their reading of any misalignment to subsequently determine how to adjust the sharpener 200 in order to produce even edges 116, 118. Because there are many specific details that need to be known to determine the adjustment needed, figuring out the adjustment needed is difficult, confusing, time consuming, and prone to user error. For example, some factors that need to be known are: the orientation of the edge height measurement device on the skate blade, the orientation of the skate in the sharpener during the sharpening, the size of the hollow 114 being ground into the skate blade, and the adjustment mechanism behavior for the sharpener 200.

Use of the optical alignment tool 210 and calibration wheel 220 may result in running the skate sharpener through an iterative process of sharpening the skate blade 100, edge checking (e.g., measuring the delta height H) using a separate tool such as an edge checker, interpreting the results of the edge checker, adjusting or calibrating the sharpener 200 for another sharpening operation, and so forth.

### B. Measurement Devices

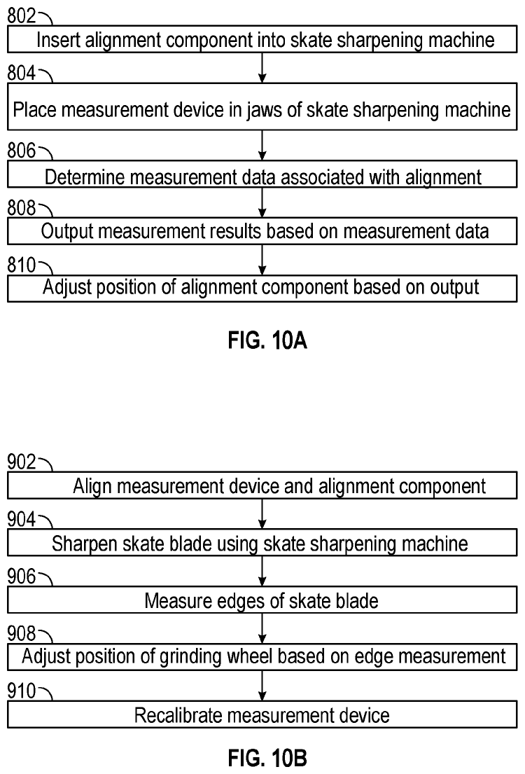

One or more of the disadvantages/limitations of the using the optical alignment tool 210 in skate sharpening system requiring manual adjustment discussed above may be overcome or eliminated by use of a measurement device described herein. For example, as discussed further herein, the measurement devices can be used to eliminate confusion in the sharpening process and deliver a more precise skate sharpening. For example, the measurement device may be configured to measure the distance between central axis 120 of the skate blade 100 and the central axis 152 of the grinding wheel 150 with a high degree of precision. In another example, the measurement devices may be configured to determine whether the central axes 120, 152 of the skate blade 100 and grinding wheel 150 are aligned without the need for a user to interpret alignment between visible indicators (e.g., the alignment tab 216 and the alignment channel 222). In some examples, the measurement devices described herein can be used to tell a user the magnitude and direction of the adjustments necessary to adjust the sharpener 200 to bring grinding wheel 150 into alignment with the skate blade 100 to produce even edges 116, 118. In some examples, the measurement devices described herein may be used with additional associated software (e.g., a sharpener application run on a computing device) to receive a digital reading from the measurement device, combine the digital reading with other data (e.g., radius of the hollow 114 of a sharpening, sharpener adjustment parameters, the direction of skate blade 100 in a sharpener, direction of measurement devices on the skate blade 100, etc.) to determine the adjustments necessary for the sharpener to provide a skate sharpening with even edges 116, 118. In some examples, the adjustments to the skate sharpener may be performed manually, semi-automatically, and/or automatically as described further herein, particularly with reference to FIGS. 10A and 10B.

a. Lens Behavior

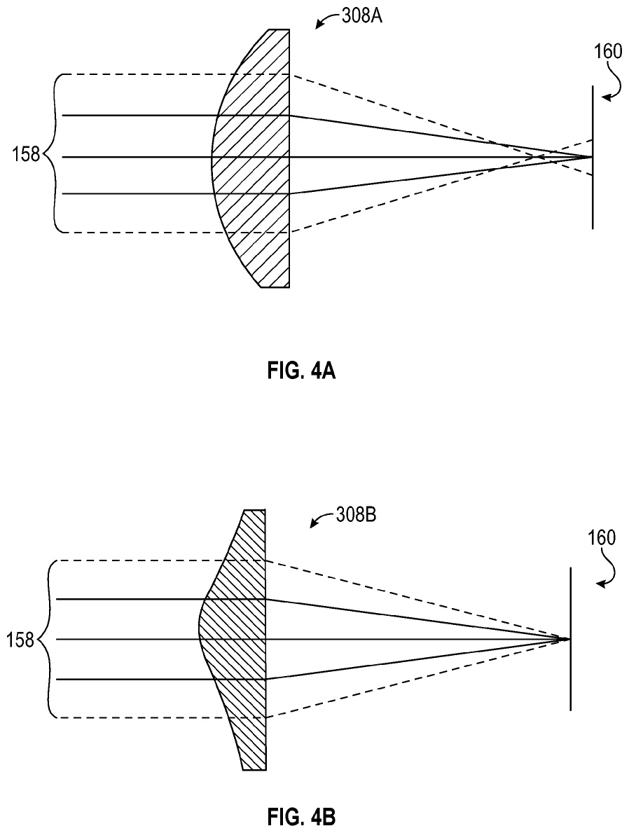

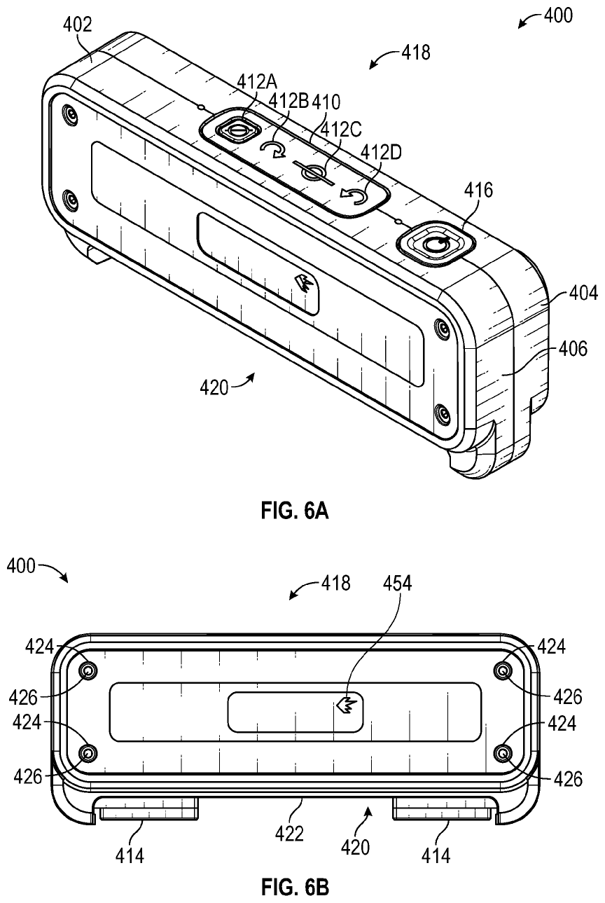

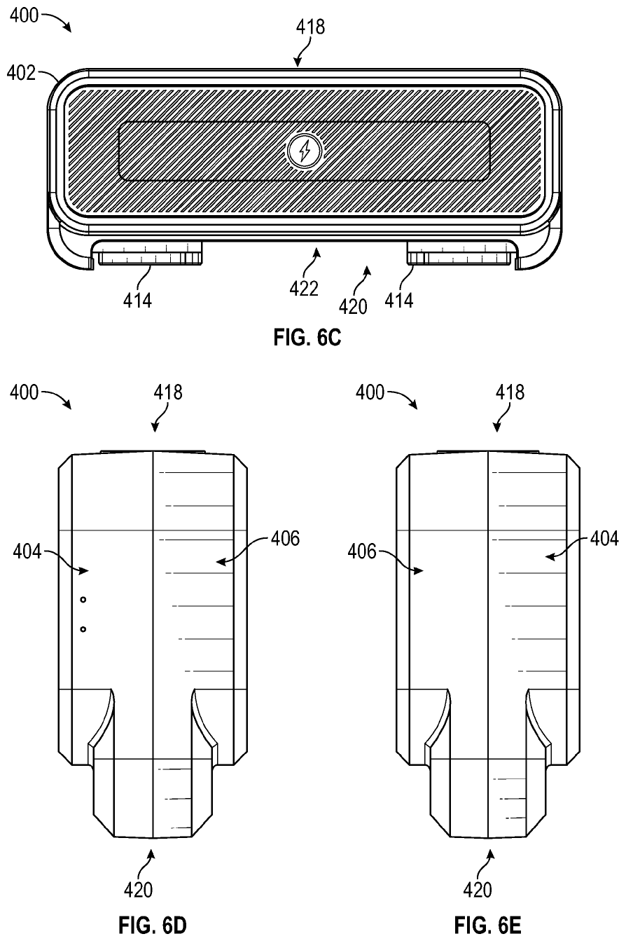

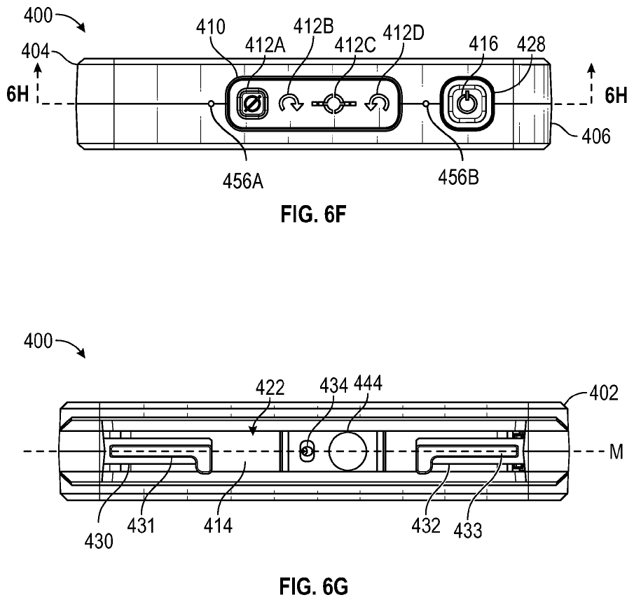

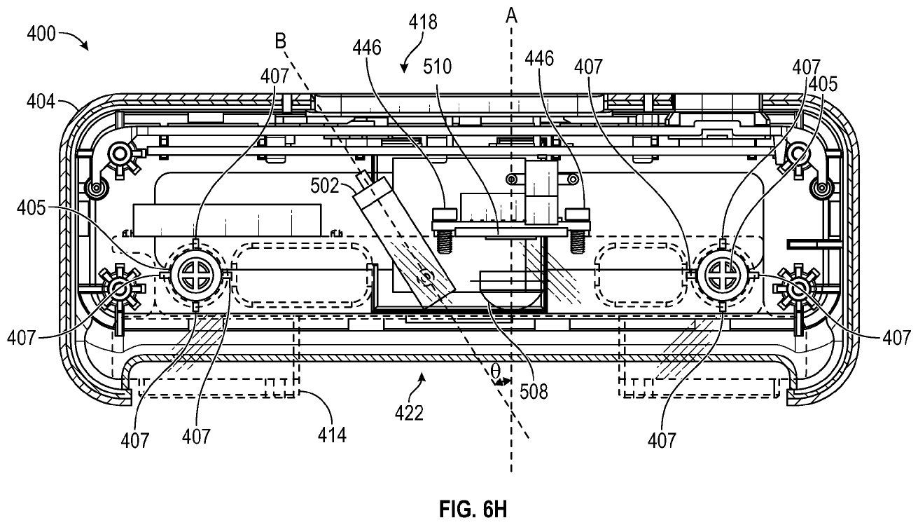

FIGS. 4A and 4B illustrate schematic side view of lens 308A and 308B respectively. As described further herein, some embodiments of the measurement devices (e.g., measurement device 400) include a lens 508 (see e.g., FIG. 6H). The lens 308A is a spheric lens and the lens 308B is an aspheric lens. The measurement device 400 can include an aspheric lens similar to the lens 308B. Use of the lens 508 in the measurement device 400 is described further with reference to at least FIG. 6H.

As shown in FIG. 4A, with the spheric lens 308A, light rays 158 entering the spheric lens 308A parallel but offset to each other create a spherical aberration where the light rays 158 are not focused at the same point on an image plane 160. In the measurement devices described herein, it is generally desirable that light rays 158 entering the lens 508 at a constant angle be focused to the same point (i.e., no spherical aberrations). Since the spheric lens 308A does not behave in this manner, it can be desirable to use an aspheric lens, such as aspheric lens 308B.

As shown in FIG. 4B, with the aspheric lens 308B, light rays 158 entering the aspheric lens 308B parallel but offset to each other do not create a spherical aberration, such that the light rays 158 are focused at the same point on the image plane 160. This behavior is a result of the curvature of the aspheric lens 308B. For example, the aspheric lens 308B is shaped to ensure that parallel light rays 158 contacting the lens at different locations, will be focused to the same point. In some configurations, the measurement devices disclosed herein utilize this behavior of aspheric lens 308B. As described further herein, the measurement devices may use the aspheric lens 308B to provide for use of a custom optical path design which positions the angle of a light emitting source (e.g., see laser 502 in FIG. 6H) incident on the target relative to the angle of the aspheric lens' 308B focal axis, and positioning the focal axis of the aspheric lens 308B perpendicular to the plane of a sensor.

b. Measurement Device Schematic Diagrams

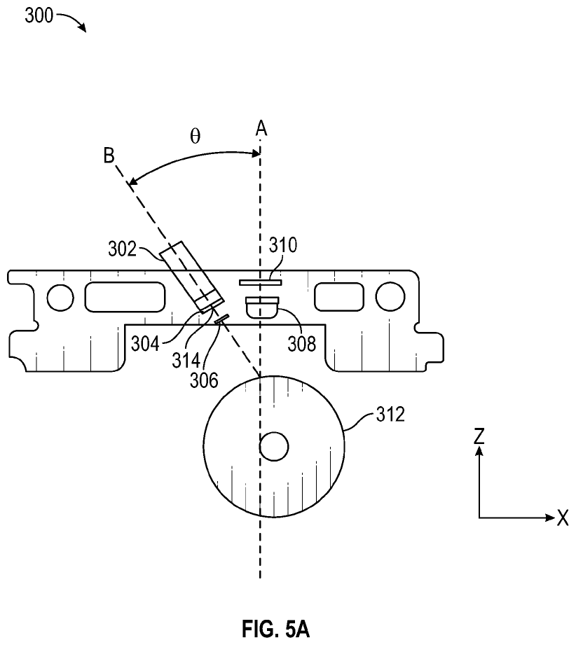

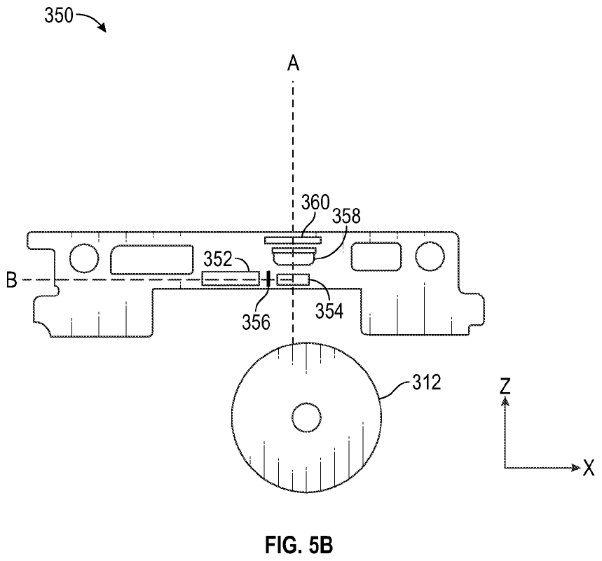

FIG. 5A illustrates a schematic diagram of an optic measurement system 300. FIG. 5B illustrates a schematic diagram of an optic measurement system 350. Either the optic measurement system 300 or the optic measurement system 350 can be utilized in the measurement devices described herein (e.g., measurement device 400 of FIG. 6A). Both the optic measurement system 300 and the optic measurement system 350 may utilize the principle of autocollimation. For example, the optic measurement system 300 and the optic measurement system 350 can include optical setups or arrangement where a collimated beam leaves an optical system and is reflected back into the same system by a reflective surface (e.g., a reflective surface on a target). Autocollimation can be used for measuring small angles of the reflective surface. Autocollimation can also be used to measure a linear distance between different portions (e.g., a first portion and a second portion) of the reflective surface. For example, the measurement of the angle can be used to determine the linear distance between two portions of the reflective surface by including a radius of curvature on reflective surface of the target. The radius alters the path of reflected light depending on the location of the radius surface and thus provides an autocollimation result that varies as the linear position of the target varies. This principle can be used to determine the distance between the central axis 120 of the skate blade 100 and the central axis 152 of the grinding wheel 150 using the measurement devices and methods described herein.

With reference to FIG. 5A, the optic measurement system 300 includes a light emitting source, such as laser 302, an aperture plate 304, a filter 306, a lens 308, a sensor 310, and a target 312. The light emitting source may be any suitable light emitting source that can generate a beam of light or a laser beam. In some examples, it may be desirable for the light emitting source to be a collimated laser. A collimated laser can be configured to generate a collimated beam of light that propagates in homogeneous mediums (e.g., air) with a low beam divergence. Low beam divergence may be desirable so that the beam radius does not undergo significant changes within moderate propagation distances.

The aperture plate 304 can include an aperture 314. The aperture 314 can be configured to reduce the spot size of the laser 302 on the target 312. Reducing the spot size of the laser 302 on the target 312 may be desirable if the spot size on the target 312 is too large. In which case, the imaged spot on the sensor 310 can take up too much area of the sensor 310 and can make it difficult to resolve small changes in an angle of a reflected beam from the surface of target 312. In some examples, the aperture 314 may be approximately circular shaped and may have a diameter between 250 μm and 1000 μm, between 350 μm and 850 μm, between 500 μm and 700 μm, or any other values or ranges of values between the foregoing. It is recognized that the size of the aperture 314 may vary between different embodiments of the measurement devices described herein and may be dependent on the type of laser 302, filter 306, lens 308, sensor 310, and/or the target 312 used in the measurement device. The size of the aperture 314 may also be dependent on the relative angles and distances between the components of the optic measurement system 300. Generally, the aperture 314 can be used to reduce the spot size of the laser 302 to a size that is proportional to the sensor 310 area and resolution required by the optic measurement system 300.

The filter 306 may be any suitable optical filter, such as, for example, a polarizing filter. The filter 306 may be configured to optimize the measurement of the position of the laser spot on the sensor 310. For example, the filter 306 may be used to optimize the signal to noise ratio. In the optic measurement system 300, the “signal” is the laser beam that is reflected from the target 312 into the sensor 310 and the “noise” is any other light or additional portion of the reflected light that can make it difficult for the hardware and/or software of the sensor 310 to accurately determine the center of the laser beam. Noise in the optic measurement system 300 may be generated in a number of ways. For example, noise may comprise light in the environment where the measurement device is being used that is not generated from the laser 302, such as light from the sky, light from room lights, etc. In another example, noise may comprise light from the laser 302 itself that is unstructured or “messy”, such as reflected light from the target 312. In some examples, the signal to noise ratio can be improved by using the filter 306 to filter at least a portion of the light going into the sensor 310 and/or at least a portion of the light generated by the laser 302. For example, to filter the light going into the sensor 310, the filter 306 may be configured to filter out wavelengths of light other than the wavelength(s) of the light generated by the laser 302. In another example, to filter out the unstructured portions of the laser beam itself, the filter 306 can be polarized, which may be desirable when using a collimated laser 302. For example, the polarizing filter 306 can help to prevent laser light that is reflected from the target 312 from spreading out into other directions, which may make the reflected laser spot on the sensor 310 messy.

While the example optic measurement system 300 shown in FIG. 5A includes the filter 306, the filter 306 is not required. However, it may be desirable for the optic measurement system 300 to include a filter 306 to prevent the sensor 310 from being over-saturated. Saturation, as the term is used herein, can refer to the level of light intensity incident on the sensor 310, relative to the level of light intensity the sensor 310 can process while generating accurate results. Similar to a person's eyes, if the light is too bright, the eyes will be over-saturated, and the person will have a difficult time seeing. If the intensity of the light is reduced to levels the human eye can handle, the person will be able to see better.

The lens 308 may use any suitable lens. For example, the lens 308 may be a spherical lens, an aspheric lens, and/or the like. As described above with reference to FIGS. 4A and 4B, in some embodiments, it may be desirable to for the lens 308 to be aspheric to eliminate spherical aberration of the laser beam generated by the laser 302.

The sensor 310 may be any suitable sensor for receiving the laser beam generated by the laser 302. For example, the sensor 310 may be a position sensitive detector (“PSD”), a charge coupled device (“CCD”), a complementary metal-oxide semiconductor (“CMOS”) device, and/or the like. When the sensor 310 receives the reflected laser beam, the light imaged onto the sensor 310 from the laser beam, referred to as the laser spot, can be converted into electrical signals. The type of electrical signal may be dependent on the electrical design specification for the particular sensor 310 used. The electrical signal may then be used to create an “image” of the light on the sensor 310. In some examples, the sensor 310 may be configured to determine the center of mass of a laser spot and output the determined center of mass directly. In another example, the sensor 310 may be configured to output raw image values and the sensor's 310 software may then resolve the center of mass of the laser spot.

The target 312 may be any suitable material that is configured to reflect light. For example, the target 312 may be smooth, have a highly polished surface, have free electrons, and/or a surface having properties that result in a reflective surface. In some embodiments, the target has a radiused surface. This radiused surface will yield different angle measurements, meaning different reflected positions on the sensor 310, for different incident locations of the laser 302 on the target 312.

The components of the optic measurement system 300 may be arranged with the laser 302 defining a laser beam axis B and the sensor 310 defining a sensor axis A, with an angle 0 therebetween. Both the laser beam axis B and the sensor axis A are aligned on an z-x plane. The laser 302 is configured to generate a laser beam that travels along the laser axis B. The aperture plate 304 may be positioned below the laser 302 along the laser beam axis B (e.g., at the same angle θ relative to the sensor axis A). In this orientation, the laser aperture 314 is aligned along the laser axis B and is configured to receive the laser beam. The sensor 310 may be positioned to the right of the laser 302 (e.g., in the positive x-direction). As noted above, the sensor 310 is configured to receive the laser beam that reflects off the target 312. The reflected laser beam from target 312 travels along a reflect beam axis in the y-z plane is received by the sensor 310. The lens 308 may be positioned on the right side of the laser 302 below the sensor 310. In this orientation, the lens 308 is aligned along the sensor axis A and is configured to receive the reflected laser beam before the sensor 310. The filter 306 may be positioned below the aperture plate 304 and below the lens 308 such that the filter 306 is between the aperture plate 304 and the target 312. In some examples, the filter 306 may aligned with the laser beam axis B. The target 312 is positioned below the laser 302, aperture plate 304, filter 306, lens 308, and sensor 310. The target 312 can be aligned in an x-z plane and the radiused surface of the target 312 can be in a y-z plane.

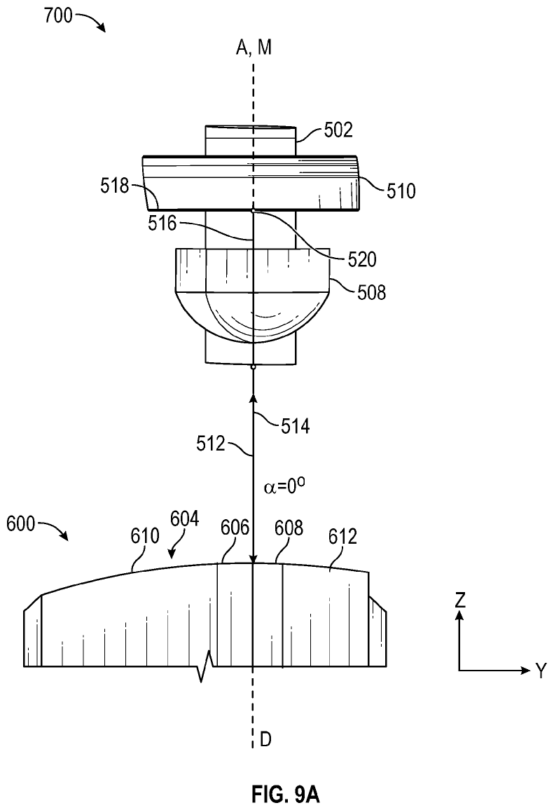

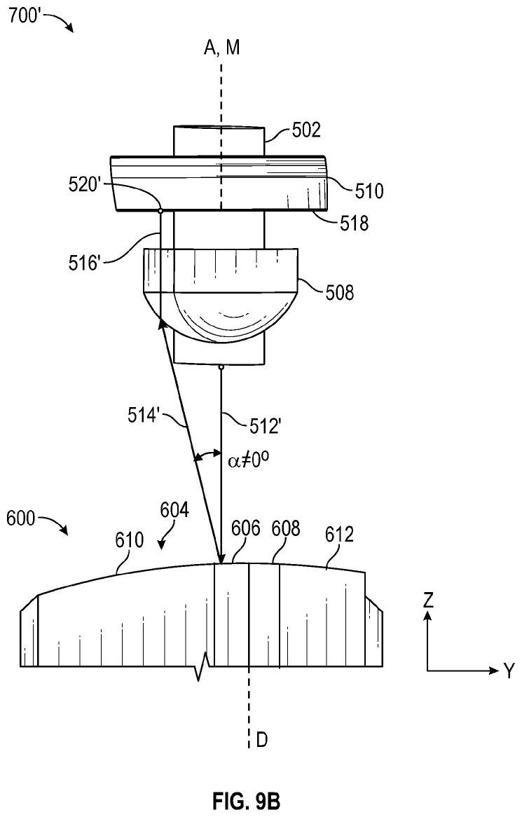

In operation, the laser 302 generates a laser beam that travels along the laser beam axis B in the x-z plane through the aperture 314 of the aperture plate 304 and through the filter 306. The laser beam travels towards and is reflected by the target 312. The reflected laser light then travels through the filter 306 and the lens 308 and is received by the sensor 310. The optical path design of the laser 302, lens 308, and sensor 310 provides the ability to measure an angle α (e.g., see FIG. 9B), which defines the angle between the reflected laser beam and the sensor axis A. Once the sensor 310 receives the reflect laser beam, a control system (not shown) utilizing sensor software can determine the angle α. For example, the control system may analyze data from the sensor 310 and determine the weighted center of mass of the laser spot received by the sensor 310. The weighted center of mass allows for the determination of the angle α based on the laser spot appearing at different locations on the sensor 310 as the position of the target 312 along the y-axis changes. As explained further herein, the optic measurement system 300 can be used to determine the Y location of the target 312 based on the angle α returned to the sensor 310 from the radiused surface of the target 312.

FIG. 5B illustrates a schematic diagram of the optic measurement system 350. The optic measurement system 350 includes light emitting source, such as a laser 352, a beam splitter 354, a filter 356, a lens 358, a sensor 360, and a target 362. The laser 352, filter 356, lens 358, sensor 360, and target 362 of the optic measurement system 350 may be similar or identical to the laser 302, filter 306, lens 308, sensor 310, and target 312 of the optic measurement system 300 respectively. For example, the components of both the optic measurement system 300 and the optic measurement system 350 may operate in a similar manner. The optic measurement system 350 includes the beam splitter 354, which allows the components of the optic measurement system 350 to be mounted at right angles to each other.

The beam splitter 354 may comprise a cube or other suitable shape and may be formed from two triangular prisms that are coupled together. For example, the two triangular prisms may be glued together at their base using polyester, epoxy, urethane-based, and/or the like adhesives. Using the beam splitter 354 can have potential advantages in mounting and setup compared to the optic measurement system 300. For example, the 90-degree configuration can make it easier to mount and align components of the optic measurement system 350 during assembly.

The components of the optic measurement system 350 may be arranged relative to the sensor axis A, defined by the sensor 360 and the lens 358. The sensor axis A extends along and defines the vertical/z-axis. In the optic measurement system 350, the laser 352 may be positioned on the left side of the sensor 360, with a laser axis B of the laser 302 being positioned at a 90 degree angle relative to the sensor axis A. The laser 352 can be configured to generate a laser beam that travels along the laser axis B. In an example where the optic measurement system 350 includes an aperture plate, the aperture plate can be positioned between the laser 352 and the filter 356 at the same 90 degree relative to the sensor axis A. In this orientation, the laser aperture would be aligned along the laser axis B and would be configured to receive the laser beam. The filter 356 may be positioned to the right of laser 352 on the laser axis B and between the beam splitter 354 and the laser 352. The beam splitter 354 may be positioned such that the beam splitter 354 is centrally aligned with both the sensor axis A and the laser axis B. The beam splitter 354 may be positioned between the lens 358 and the target 362 on the sensor axis A.

The lens 358 may be positioned above the beam splitter 354 centrally on the sensor axis A below the sensor 360 and at a 90 degree angle relative to the laser axis A. In this orientation, the lens 358 is aligned along the sensor axis A and is configured to receive the reflected laser beam before the sensor 360. The sensor 360 may be positioned above the lens 358 and centrally on the sensor axis A. The sensor 360 is configured to receive the laser beam that reflects off the target 362 and travels through the beam splitter 354. The target 362 is positioned below the lens 358 and the sensor 360. The target 362 can be aligned in an x-z plane and the radiused surface of the target 362 can be in a y-z plane.

In operation, the laser 352 generates a laser beam that travels along the laser beam axis B in the x-z plane (optionally through an aperture of an aperture plate) through the filter 356. The laser beam travels towards and is reflected by the beam splitter 354 and travels towards the target 362. The reflected laser light then travels back through the beam splitter 354, through the lens 358 and is received by the sensor 360. The optical path design of the laser 352, lens 358 and sensor 360 provides the ability to measure the angle α (e.g., see FIG. 9B), which defines the angle between the reflected laser beam and the sensor axis A. Once the sensor 360 receives the reflected laser beam, a control system (not shown) utilizing sensor software can determine the angle α. For example, the control system may analyze data from the sensor 360 and determine the weighted center of mass of the laser spot received by the sensor 360. The weighted center of mass allows for the determination of the angle α based on the laser spot appearing at different locations on the sensor 360 as the position of the target 362 along the y-axis changes. As explained further herein, the optic measurement system 350 can be used to determine the Y location of the target 362 based on the angle α returned to the sensor 360 from the radiused surface of the target 362.

c. Measurement Device

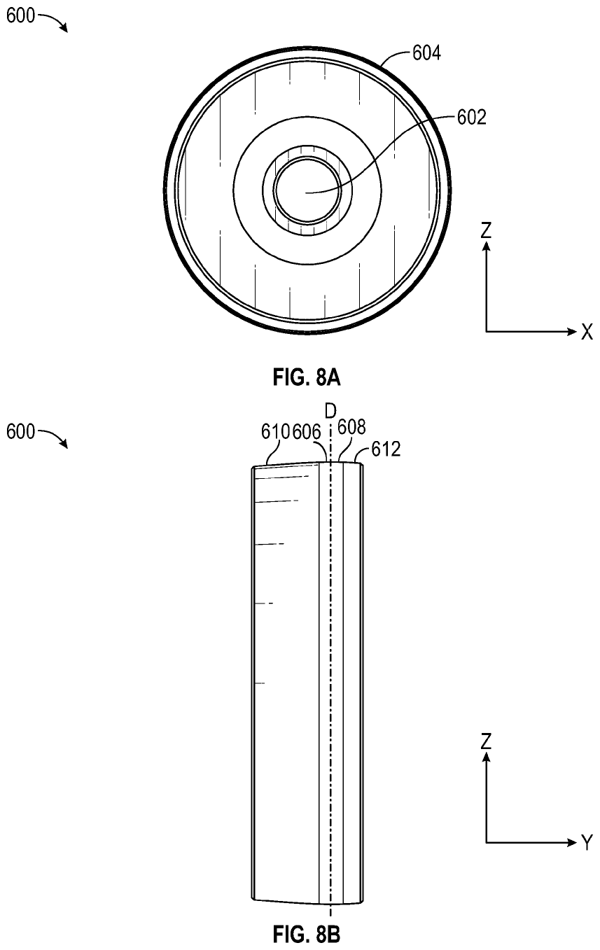

FIGS. 6A-6H illustrate an embodiment of a measurement device 400. The measurement device 400 may be configured to be used with a calibration wheel 600 (e.g., see FIG. 8A and 8B) or a grinding wheel 150 in a skate sharpening system, such as the sharpener 200. References made to using the measurement device 400 with the calibration wheel 600 are understood to apply to the grinding wheel 150 and vice versa, unless otherwise specified. FIG. 6A illustrates a front perspective view of the measurement device 400. The measurement device 400 includes an external housing 402, a control panel 410, an internal frame 414 (also referred to herein as the frame 414), a power button 416, an optics system 500 (e.g., see FIG. 6H), and a control system (not shown).

In some embodiments, the measurement device 400 may include a digital display (e.g., an LCD-type display), which may disposed anywhere on the measurement device 400. In one example, the digital display can be on the front of the measurement device 400. is recognized that the measurement device 400 does not require a display and, in some examples, including the embodiment illustrated, the external housing 402 may include a deboss area which can be used to place a logo on, such as, for example, a sticker. In an embodiment where the measurement device 400 includes a display, the display may comprise an electronic screen that is configured to display measurements and other information generated by the control system. Any suitable display device can be used for the display.

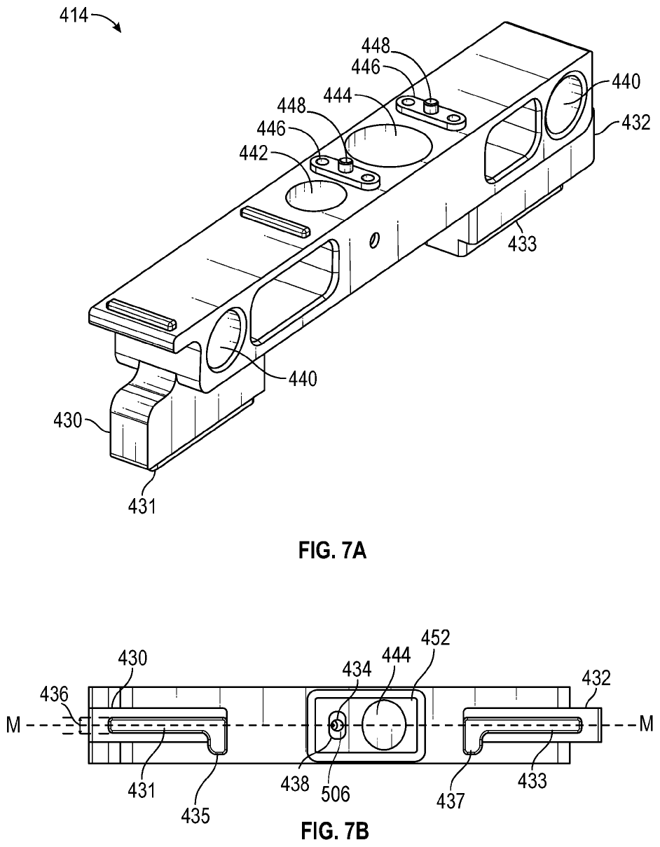

FIG. 6B illustrates a front view of the measurement device 400 and FIG. 6C illustrates a back view of the measurement device 400. As shown, the external housing 402 may comprise a rear housing 404 and a front housing 406. The external housing 402 may be roughly rectangular shaped with rounded edges. However, it is recognized that the external housing 402 may be any suitable shape. The external housing 402 may be manufactured using any suitable material, such as, for example, one or more of: a plastic, a metal, a molded plastic, a rubber, a liquid silicone rubber molding, an over-molded rubber-like material, and/or the like In some cases, it may be desirable for the measurement device 400 to be resistant to damage when the measurement device 400 is dropped from a normal operating height (e.g., less than 6 feet). As shown in FIGS. 6D and 6E, which illustrate a left side view and a right side view of the measurement device 400 respectively, the rear housing 404 and the front housing 406 may be coupled together to form the external housing 402. The external housing 402 may include a top side 418, a bottom side 420, and an opening 422. The bottom side 420 includes the opening 422. The opening 422 may be formed by a gap between the rear housing 404 and front housing 406. The opening is configured to allow at least a portion of the frame 414 to extend outside of the external housing 402. For example, as discussed further with reference to FIGS. 7A and 7B, the frame 414 can include one or more blade members (e.g., a first blade member 431 and a second blade member 433) which extend out of the opening 422 and are configured to be secured within the jaws 202 of the sharpener 200. The opening 422 can extend through the external housing 402 such that a hole extends into the internal body of the external housing 402 when the frame 414 is not positioned between the rear housing 404 and the front housing 406.

The front housing 406 may include a plurality of fastener holes 424 and a cutout 454. The plurality of fastener holes 424 may be recessed into the front housing 406. The plurality of fastener holes 424 are configured to receive the plurality of fasteners 426. The plurality of fasteners 426 may be bolts, screws, and/or other types of fasteners that are configured to secure the rear housing 404 to the front housing 406, with the frame 414 positioned between the rear housing 404 and front housing 406. The cutout 454 may be positioned over a light source (e.g., an LED) such that when the light source emits light, the cutout 454 may be illuminated. In some embodiments, the measurement device 400 may control the cutout 454 light source to generate bursts of light visible through the cutout 454 to communicate states of operation of the measurement device 400.

With reference to FIG. 6H, which illustrates a front view of the measurement device 400 with select components of the measurement device 400 (e.g., the rear housing 404, components of the control system, etc.) removed and the frame 414 in dotted lines, the rear housing 404 may include one or more frame holders 405. For example, in the embodiment illustrated, the rear housing 404 includes two frame holders 405. The frame holders 405 may be extensions that extend towards the front housing 406. The frame holders 405 can be any shape, such as square, rectangular, circular, and/or the like. Similarly, the front housing 406 may include identical frame holders 405 (not shown) that extend towards the rear housing 404. The combination of the frame holders 405 of the rear housing 404 and front housing 406 are used to suspend the frame 414 within the external housing 402. For example, the frame holders 405 can extend through housing mounts 440 of the frame 414 (e.g., see FIG. 7A). In some embodiments, the frame holders 405 can include a series of projection 407 on the internal surfaces of the rear housing 404 and front housing 406 such that a gap is maintained between the internal surfaces of the external housing 402 and the frame 414.

In some embodiments, the frame holders 405 are configured to provide vibrational isolation to the frame 414, which houses the optics system 500. For example, the frame holders 405 may be formed from or include a compliant material. In another example, the frame holders 405 may include posts that are configured to receive a compliant material. In another example, the frame holders 405 may be springs or a material with spring-like properties. As shown in FIG. 6H, an outline of the frame 414 is illustrated in position on the inside of the rear housing 404. The frame holders 405 engage with or are received within the housing mounts 440 of the frame 414, such that the frame 414 may be suspended between the four frame holders 405 (e.g., two frame holders 405 on the rear housing 404 and two frame holders 405 on the front housing 406). As a result of this arrangement, the frame 414 can, under load, move relative to the external housing 402. For example, relative movement of the frame 414 may help to dissipate any shocks received by the measurement device 400. For example, if the measurement device 400 is dropped, the frame 414 can move relative to the external housing 402 as a result of the frame holders 405, acting to dissipate the shock received and protect the optics system 500.

In some embodiments, the frame 414 can be coupled to the measurement device 400 without the use of a shock isolation system (e.g., the frame holders 405). For example, as noted below, in some embodiments, the plurality of fasteners 426 may extend through both the external housing 402 and the frame 414 to secure the frame 414 to the external housing 402. Other conventional coupling means can also be used. In this embodiment, the measurement device 400 relies on the shock isolation properties of the external housing 402, with or without over molding, for the protection of the frame 414 and the optics system 500.

FIG. 6F illustrates a top view of the measurement device 400. As shown in FIG. 6F, the control panel 410 and power button 416 may be located on the top side 418 of external housing 402. The control panel 410 can include a plurality of control buttons/indicators 412. For example, in the embodiment illustrated, the control panel 410 includes a first button 412A, first indicator 412B, a second indicator 412C, and a third indicator 412D. More or less control buttons/indicators 412 are possible. As explained further below, any indicator can be configured as a button and any button can be configured as an indicator. When the control buttons/indicators 412 are configured as indicators, the measurement device 400 may include one or more light sources (e.g., LEDs) positioned below the indicators 412 such that the indicator 412 is illuminated for the user. While the control panel 410 is positioned on the top side 418 of the external housing 402, it is recognized that the control panel 410 can be located on any side of the external housing 402. However, having the control panel 410 on the top side 418 may provide certain advantages, such as allowing a user to read the indicators and operate the measurement device 400 when positioned within the sharpener 200.

The first button 412A may be configured to be partially compressed when the user pushes on the first button 412A. As explained further herein, in some embodiments, the measurement device 400 can be configured to control components of the sharpener 200, such as the position of the grinding wheel 150 along the y-axis. When configured as control buttons, the control buttons/indicators 412 can be used to transmit instructions (e.g., via Bluetooth) to the sharpener 200 and/or to a computing device (e.g., the user device 1000) which can be used to run an application associated with the sharpener 200. For example, as explained further herein, the measurement device 400 may transmit instructions to the user device 1000, which can be used to control the sharpener 200. The first button 412A may be used to calibrate or zero the current position of the calibration wheel 600 relative to the measurement device 400. Use of the first button 412A may set a new zeroed position for the measurement device 400 based on recalibrating the measurement device, as described with reference to the method 900 of FIG. 10B.

The second indicator 412C may be configured to indicate when the measurement device 400 is aligned with the calibration wheel 600. For example, when the calibration wheel 600 is aligned with the measurement device 400, the second indicator 412C may become illuminated to indicate to the user that the y-position of the calibration wheel 600 is correct and no further adjustment of the adjustment component that supports the calibration wheel 600 and the grinding wheel 150 is required.

The first indicator 412B and the third indicator 412D can be configured to indicate when the measurement device 400 is not aligned with the calibration wheel 600 and which direction adjustment is required. When the first or third indicators 412B, 412D are illuminated, a user can determine that a change in the y-position of the adjustment component is needed for alignment. The first indicator 412B may indicate that a clockwise adjustment (e.g., in the negative y-direction) is required and the third indicator 412D may indicate that a counterclockwise adjustment (e.g., in the positive y-direction) is required, or vice versa.

In some embodiments, any of the indicators 412B, 412C, 412D can be configured as control buttons, and can be used to transmit instructions (e.g., via near field communication) to the sharpener 200 and/or to a computing device (e.g., the user device 1000) like the first button 412A. For example, the user may push the second indicator 412C to indicate to the sharpener 200 that the calibration wheel 600 is in the desired alignment position for a sharpening operation and the sharpener 200 may store this information for future operations. The first indicator 412B and the third indicator 412D can be used to cause a change in the y-position of the adjustment component. The first indicator 412B may results in clockwise adjustment (e.g., in the negative y-direction) and the third indicator 412D may result in counterclockwise adjustment (e.g., in the positive y-direction) or vice versa. For example, the first indicator 412B can be used to cause the grinding wheel 150 to translate in a first direction (e.g., in the negative y-direction) and the third indicator 412D can be used to cause the grinding wheel 150 to translate in a second direction (e.g., in the positive y-direction).

The power button 416 is configured to power on and power off the control system. While the power button 416 is positioned on the top side of the external housing 402, it is recognized that the power button 416 can be located on any side of the external housing 402. In the example illustrated, the power button 416 is positioned within a recess 428 of the external housing 402. The power button 416 may be configured to be partially compressed when the user pushes on the power button 416.

In some embodiments, the measurement device 400 may include one or more digital indicators (e.g., LEDs) to assist the user in operating the measurement device 400. For example, the digital indicators can indicate power, Bluetooth connection, recalibrations, and/or the like. In one example, a fourth indicator 456A may be used to indicate that the measurement device 400 or the sharpener 200 has been recalibrated, such as when the user presses the first button 412A, and a fifth indicator 456B may be used to indicate power, Bluetooth connection, and the like, or vice versa.

FIG. 7A illustrates a perspective isolation view of the frame 414. FIG. 7B illustrates a bottom isolation view of the frame 414. The frame 414 can be shaped to fit within the external housing 402 and may be connected to or suspended between at least one of the rear housing 404 and the front housing 406 via the housing mounts 440, as described above with reference to FIG. 6H. In some embodiments, the frame 414 may be securely coupled to the measurement device 400. The frame 414 may be any suitable material. For example, in some cases, the frame 414 may be a plastic or a metal. As described further herein, the frame 414 is configured to support additional components of the measurement device 400, such as components of the optics system 500 and the control system.

The frame 414 may include a first projection 430, a first blade member 431, a second projection 432, a second blade member 433, an internal aperture 434, a filter recess 438, a laser hole 442, a lens hole 444, a sensor mount 446, and protective glass 452. The projections 430, 432 may extend from the bottom of the frame 414 in a direction away from the top side 418 of the measurement device 400 when the measurement device 400 is assembled. The projections 430, 432 are configured to support the blade members 431, 433, which can extend from the bottoms of the projections 430, 432 in a direction away from the top side 418 of the measurement device 400. The blade members 431, 433 are configured to be received in the jaws 202 of the sharpener 200. The projections 430 are shaped to simulate an ice skate's skate blade holder, which would sit on top of the jaws 202 during a sharpening operation when the blade 100 was not removed from the skate. As discussed above, the jaws 202 secure the skate blade 100 to the sharpener 200 during sharpening operations. When the measurement device 400 is used to measure the alignment of the sharpener 200, the projections 430, 432 simulate the skate blade holder and sit on top of the jaws 202. The projections 430, 432 may have a flat bottom surface, to help support the measurement device 400 on the jaws 202. In this arrangement, the blade members 431, 433 extend into and are secured to the sharpener 200 via the jaws 202. As such, the blade members 431, 433 may be shaped to resemble the skate blade 100. For example, the blade members 431, 433 can be rectangularly shaped. The blade members 431, 433 may have a width 436 that is approximately equal to the width of an average skate blade 100 (e.g., approximately the same size as the blade thickness 122 of the skate blade 100).

In some embodiments, one or both of the blade members 431, 433 can include an alignment feature. For example, in the embodiment illustrated, the first blade member 431 includes alignment member 435 and the second blade member includes alignment member 437. The alignment members 451, 437 assist the user in ensuring that the measurement device 400 is inserted into the sharpener 200 in the same orientation each time the measurement device 400 is used. As noted above, the blade members 431, 433 may be shaped to extent through and be secured via the jaws 202. In some sharpeners 200, the jaws 202 include corresponding alignment features (e.g., notches). As such, the shape of the alignment members 435, 437 can differ for use in different sharpeners. In the embodiment illustrated, the alignment members 435, 437 are projections or nubs that extend from the blade members 431, 433. The alignment members 435, 437 may be at approximately a 90 degree angle relative to the blade members 431, 433. As such, the combination of the blade members 431, 433 and alignment members, 435, 437 resemble L-shaped projections extending from the projections 430, 432 away from the top side 418. When the jaws 202 includes notched alignment features, the alignment members 435, 437 may extend through the notches to ensure the measurement device 400 is correctly orientated relative to the sharpener 200.

The internal aperture 434 of the frame 414 can be configured to reduce the spot size of a laser 502 of the optics system 500. The internal aperture 434 serves the function of the aperture plate 304 and aperture 314 discussed with reference to FIG. 3A. The laser hole 442 is configured to receive and support the laser 502 (e.g., as shown in FIG. 6H). The laser 502 may be secured within the laser hole 442. A central axis of the laser hole 442 can be aligned with a central axis of the internal aperture 434, such that both central axis are aligned with the laser axis B.

In some cases, the internal aperture 434 may be approximately circular shaped and may have a diameter between 250 μm and 1000 μm, between 350 μm and 850 μm, between 500 μm and 700 μm, or any other values or ranges of values between the foregoing. It is recognized that the size of the internal aperture 434 may vary between different embodiments of the measurement device 400 and may be dependent on the type of laser 502, filter 506, lens 508, sensor 510 of the optics system 500 and/or the reflective outer surface 604 of the calibration wheel 600 with the measurement device 400. The size of the internal aperture 434 may also be dependent on the relative angles and distances between the components of the optics system 500. Generally, the internal aperture 434 can be used to reduce the spot size of the laser 502 to a size that is proportional to the sensor 510 area and resolution required by the optics system 500, similarly to the laser aperture 314 of the optic measurement system 300. In some embodiments, the internal aperture 434 can be machined into the frame 414. In some embodiments, the internal aperture 434 can be an external component that is coupled to the frame 414. In some embodiments, the laser 502 may include an aperture component and the internal aperture 434 may not be used in the measurement device 400.

The lens hole 444 is configured to support a lens 508 of the optics system 500. The lens hole 444 may extend through the frame 414. A central axis of the lens hole 444 may be aligned with an define the sensor axis A of the lens 508 and sensor 510, as explained further below. In the assembled configuration, the lens 508 can be secured within the lens hole 444. As discussed below, in some embodiments, a filter 506 of the optics system 500 may be mounted to the frame 414. For example, the frame 414 can include a recess 438 for receiving the filter 506 such that the filter 506 can be positioned over the internal aperture 434. In some embodiments, the same filter or a separate filter can be positioned on the frame 414 over the lens hole 444.

The protective glass 452 may be positioned on the bottom of the frame 414. The protective glass 452 can be configured to seal the bottom of the lens hole 444 and the bottom of the laser hole 442. The protective glass 452 can prevent contaminants, moisture, and the like from the optical areas of the frame 414. The tops of the lens hole 444 and laser hole 442 may also include a seal. For example, the laser hole 442 may include an adhesive positioned around the body of the laser 502 in the laser hole 442 such that the laser 502 is fixed to the frame 414. The lens hole 444 may include a gasket that is positioned between the PCB and that is coupled to the sensor 510 and the frame 414.

The sensor mounts 446 are configured to support and secure a sensor 510 of the optics system 500 to the frame 414. For example, the sensor mounts 446 can include a plurality of holes that can receive fasteners such that the sensor 510 can be mounted to the frame 414. Other suitable means of securing the sensor 510 can also be used. The sensor mounts 446 are positioned on both sides of the lens hole 444 such that the sensor 510 is positioned above the lens 508 in the assembled configuration. The sensor mounts 446 may include dowels 448. The dowels 448 may be projections extending away from the sensor mounts 446 in a direction towards the top side 418. The dowels 448 can be positioned between the plurality of holes of the sensor mounts 446. The dowels 448 can help position the sensor 510 accurately above the lens hole 444 such that the sensor 510 is aligned with the sensor axis A.

The frame 414 includes a central axis M. The central axis M may represent the central axis 120 of the skate blade 100. The central axis M extends through the centers of the projections 430, 432. The central axis M is aligned with the x-axis when the measurement device 400 is inserted in the sharpener 200. Additionally, the central axis M crosses the center of the internal aperture 434 and the lens hole 444 of the frame 414. As such, the laser generated by the laser 502 crosses the central axis M in operation. For example, the laser generated by the laser 502 may travel along a plane aligned with the x-axis and the z-axis. In some embodiments, the central axis M may be positioned at a defined distance from a center axis 120 of the skate blade 100.

FIG. 6H illustrates a front view of the measurement device 400 with select components of the measurement device 400 (e.g., the front housing 406, components of the control system, etc.) removed to better illustrate the optics system 500. The optics system 500 may comprise a light emitting source 502, a filter 506 (e.g., see FIG. 7B), a lens 508, and a sensor 510. Like components of the optics system 500 may be similar or identical to like components of the optic measurement system 300. For example, the components of both the optic measurement system 300 and the optics system 500 may operate and be arranged in a similar manner.

With continued reference to FIG. 6H, the light emitting source 502 may comprise any suitable light source that can transmit light that can be received by the sensor 510. The light source can emit light within the visible spectrum of light or outside the visible spectrum of light. In the illustrated embodiment, the light emitting source comprises a laser 502. In this example, the laser 502 may be any suitable laser that can generate a beam of light or a laser beam. In some examples, it may be desirable for the laser 502 to be a collimated laser. A collimated laser is configured to generate a collimated beam of light that propagates in homogeneous mediums (e.g., air) with a low beam divergence. Low beam divergence may be desirable so that the beam radius does not undergo significant changes within moderate propagation distances.

In some embodiments, the measurement device 400 may include an alternative energy emitting source rather than a light emitting source. For example, the measurement device 400 may utilize any energy emitting source that could cause a disruption or modification of the generated signal that could be detected by a corresponding sensor, such as the sensor 510.

The filter 506 may comprise any suitable material that can allow the laser beam to pass through it without compromising the laser beam. For example, the filter 506 may be a glass plate with an optical filter, such as, for example, a polarizing filter. The filter 506 may be configured to optimize the measurement of the position of the laser spot on the sensor 510. For example, the filter 506 may be used to optimize the signal to noise ratio. In the optics system 500, the “signal” is the laser beam that is reflected from the calibration wheel 600 and the “noise” is any other light or additional portion of the reflected light that can make it difficult for the control system to accurately determine the center of the laser beam. Noise in the optics system 500 may be generated in a number of ways. For example, noise may comprise light in the environment where the measurement device is being used that is not generated from the laser 502, such as light from the sky, light from room lights, etc. In another example, noise may comprise light from the laser 502 itself, that is unstructured or “messy” such as reflected light from the calibration wheel 600. In some examples, the signal to noise ratio can be improved by using the filter 506 to filter at least a portion of the light generated by the laser 502. For example, to filter out the unstructured portions of the laser beam itself, the filter 506 can be polarized, which may be desirable when using a collimated laser 502. For example, the polarizing filter 506 can help to prevent laser 502 light that is reflected from the calibration wheel 600 from spreading out into other directions, which may make the reflected laser spot on the sensor 510 messy. In some embodiments, the optics system 500 can include a first filter to filter light from the laser 502 and a second filter to filter reflected light directed towards the lens 508.

The lens 508 may comprise any suitable lens. For example, the lens 508 may comprise a spherical lens, an aspheric lens, and/or the like. As described above with reference to FIGS. 4A and 4B, in some examples, it may be desirable to for the lens 508 to be aspheric to eliminate spherical aberration of the laser beam generated by the laser 502.

The sensor 510 may comprise any suitable sensor for receiving the laser beam generated by the laser 502. For example, the sensor 510 may comprise a position sensitive detector (“PSD”), a charge coupled device (“CCD”), a complementary metal-oxide semiconductor (“CMOS”) device, and/or the like. When the sensor 510 receives the reflected laser beam, the light imaged onto the sensor 510 from the laser beam, referred to as the laser spot, can be converted into electrical signals. The type of electrical signal may be dependent on the electrical design specification for the particular sensor 510 used. The electrical signal may then be used by the control system to create an “image” of the light on the sensor 510. In some examples, the sensor 510 may be configured to determine the center of mass of a laser spot, and thus output the determined center of mass directly. In another example, the sensor 510 may be configured to output raw image values and the control system may then determine the center of mass of the laser spot. The control system may include software (e.g., computer-executable instructions) written to control the sensor(s) 510 and the software may be customized to each sensor 510 to optimize performance of the sensor 510 for use in the measurement device 400.

When the measurement device 400 is in an assembled configuration, as shown in FIGS. 6A-6G, the rear housing 404 is coupled to the front housing 406 with the frame 414, the optics system 500, and the control system positioned within the external housing 402. As noted above, the external housing 402 may be coupled to the rear housing 404 using the plurality of fasteners 426. In some examples, the plurality of fasteners 426 are slotted through the plurality of fastener holes 424 and secured to holes (e.g., threaded holes) in the rear housing 404. In some embodiments, the frame 414 includes holes to allow the plurality of fasteners 426 to pass through the frame 414, while in other embodiments, the frame 414 is shaped such that the plurality of fasteners 426 can extend between the front housing 406 and the rear housing 404 without contacting the frame 414.

FIGS. 8A and 8B illustrate a calibration wheel 600 that can be used with the measurement device 400. FIG. 8A shows a front view of the calibration wheel 600 (e.g., in the z/x-plane) and FIG. 8B shows a side view of the calibration wheel 600 (e.g., in the z/y-plane). The calibration wheel 600 can be configured to be used with a skate sharpening system (e.g., the sharpener 200). When using the measurement device 400 for an alignment, the grinding wheel 150 can be removed from the sharpener 200 and the calibration wheel 600 can be inserted in the sharpener 200 in the place of the grinding wheel 150. The calibration wheel 600 can include same mounting geometry and datums as the grinding wheel 150.

The calibration wheel 600 can include a mount hole 602 and a reflective outer surface 604. The mount hole 602 may be shaped such that the calibration wheel 600 can be mounted to the sharpener 200, as described above. The reflective outer surface 604 may be any suitable material that is configured to reflect light. For example, the reflective outer surface 604 may be smooth, have a highly polished surface, have free electrons, and/or properties that result in a highly reflective surface. In some embodiments, the calibration wheel 600 can be assembled by using an existing calibration wheel (e.g., the calibration wheel 220) or an existing grinding wheel (e.g., the grinding wheel 150) and adding a reflective component to the outer surface.

The reflective outer surface 604 of calibration wheel 600 can have a radius of curvature about the x-axis. The calibration wheel 600 includes a central axis D. The central axis D defines a first radiused portion 606 and a second radiused portion 608 of the reflective outer surface 604. For example, the first radiused portion 606 may be the outer surface of the calibration wheel 600 to the left of the central axis D as illustrated in FIG. 8A and the second radiused portion 608 may be the outer surface of the calibration wheel 600 to the right of the central axis D as illustrated in FIG. 8A. In some embodiments, there may be a consistent radius of curvature between the first radiused portion 606 and the second radiused portion 608.

In operation, the calibration wheel 600 serves as the target for the laser 502 of the measurement device 400. The optics system optics system 500 of the measurement device 400 can be calibrated for the calibration wheel 600. For example, the radius' of the first radiused portion 606 and the second radiused portion 608 are integrated into the control system of the measurement device 400. As such, the measurement device 400 can determine the position of the central axis M of the measurement device 400 relative to the central axis D of the calibration wheel 600 based on the reflected beam received by the sensor 510. The use of the measurement device 400 with the calibration wheel 600 is described below with reference to FIGS. 9A and 9B.

In some embodiments, the calibration wheel 600 can include one or more flat portions on the reflective outer surface 604 on either side of the radiused portions 606, 608. For example, as shown in FIG. 8B, the calibration wheel 600 can include a first flat portion 610 and/or a second flat portion 612. The first radiused portion 606 can transition to the first flat portion 610 moving away from the central axis D and the second radiused portion 608 can transition to the second flat portion 612 moving away from the central axis D. The flat portions 610, 612 may be portions of the reflective outer surface 604 with a consistent angle relative to the y-axis. The flat portions 610, 612 may be used to prevent the optics system 500 from going out of range when the central axis D of the calibration wheel 600 is significantly misaligned with the central axis M of the measurement device 400. For example, when the laser beam generated by the laser 502 reflects of one of the flat portions 610, 612, the control system of the measurement device 400 may be configured to determine which side the nominal the measurement is on, even when the offset between the central axes D and M is large. Including flat portions 610, 612 may provide the advantage of ensuring the sensor 510 always receives the reflected beam, event when the offset between the central axes D and Mis large. For example, if the calibration wheel 600 only included radiused portions, some reflected beams may miss the sensor 510. In some embodiments, the calibration wheel 600 may not include the flat portions 610, 612 and the first radiused portion 606 and the second radiused portion 608 may extend to the edges of the calibration wheel 600.

In some embodiments, the calibration wheel 600 may include features or be configured to be used with another component system to protect the reflective outer surface 604. In one example, the calibration wheel 600 may be used with a protective outer cover. The outer cover may be configured to receive the calibration wheel 600 such that the calibration wheel 600 is secured within the outer cover. The outer cover may be transparent such that the laser beam can travel through the outer cover without changing path. In another example, the outer cover may include cutout or windows such that the laser can still be reflected by the reflective outer surface 604 without the outer cover impacting the laser. In some embodiments, the outer cover may include ribs or other protrusions to protect the calibration wheel 600 from being damaged if dropped. In some embodiments, the outer cover could also be used for clocking or setting the angle that the calibration wheel 600 is positioned in when connected to the sharpener 200.

As discussed with reference to FIGS. 7A and 7B, the various components of the optics system 500 may be supported by one or more of the frame 414, the rear housing 404, and the front housing 406. Generally, it is desirable for the optics system 500 to be primarily supported by the frame 414 to protect the optics system 500 from shock events, as described above. The components of the optics system 500 may be arranged in a similar manner to the components of the optic measurement system 300. For example, the components of the optics system 500 are arranged relative with the laser 502 defining a laser beam axis B and the sensor 510 defining a sensor axis A, with an angle θ therebetween.

With reference to FIG. 6H, in some examples, the sensor axis A is the central axis of the of the lens 508 and the sensor 510. The sensor axis A extends along and defines the vertical/z-axis. The components of the optics system 500 to the right of the sensor axis A are in the positive x-direction and the components of the optics system 500 to the left of the sensor axis A are in the negative x-direction. In the optics system 500, the laser 502 may be positioned on the left side of the sensor axis A with a laser axis B of the laser 502 being at an angle θ relative to the sensor axis A. The laser 502 is configured to generate a laser beam that travels along the laser axis B. Both the laser axis B and the sensor axis A may be in the same z/x-plane. As noted above, the frame 414 can include the internal aperture 434 that may be machined into the frame 414 to align with the laser axis B. The internal aperture 434 may be configured to reduce the spot size of the laser 502 on the reflective outer surface 604 of the calibration wheel 600. The filter 506 (e.g., see FIG. 7B) may be positioned below the laser 502 (e.g., in the recess 438). In some examples, the filter 506 may be at a 90 degree angle (i.e., perpendicular) to the sensor axis A. In this orientation, the filter 506 is aligned along the laser axis B and is configured to receive the laser beam. As noted above, the sensor 510 is configured to receive the laser beam that reflects off the reflective outer surface 604 of the calibration wheel 600. When the central axis D of the calibration wheel 600 is not aligned with the central axis M of the frame 414, the reflected beam travels along a reflected beam axis C. Because the radius of curvature of the reflective outer surface 604 is in a z/y-plane, the reflected beam axis Cis also in a z/y-plane. An angle α can be defined as the angle between the sensor axis A and the reflected beam axis C. As discussed below, the measurement device 400 can be configured to determine the linear y-position of the calibration wheel 600 based on the angle α. When the central axis D of the calibration wheel 600 is aligned with the central axis M of the frame 414, the reflected beam travels along the sensor axis A and is received by the sensor 510, such that the angle α is zero.

In operation, the laser 502 generates a laser beam that travels along the laser beam axis B through internal aperture 434 and through the filter 506. The laser beam travels towards and is reflected by the reflective outer surface 604 of the calibration wheel 600 or the grinding wheel 150. The reflected laser beam then travels through the lens 508 and is received by the sensor 510. The optical path design of the laser 502, lens 508, and sensor 510 provides the ability to measure the angle α, which varies depending on which portion of the reflective outer surface 604 the laser beam hits. For example, when the laser beam strikes the central axis D of the calibration wheel 600, the angle α is approximately zero. When the laser beam strikes the reflective outer surface 604 that is not on the central axis D (e.g., the radiused portions 606, 608 or the flat portions 610, 612), the angle α is non-zero. Once the sensor 510 receives the reflect laser beam, the control system determines the angle α. For example, the control system may analyze data from the sensor 510 and determine the weighted center of mass of the laser spot received by the sensor 510. The weighted center of mass allows for the determination of the angle α based on the laser spot appearing at different locations on the sensor 510 as the angle α changes with the y-position of the calibration wheel 600. The combination of the optics system 500 and the control system can be used to determine whether the central axis M of the measurement device 400 is aligned with the central axis D of the calibration wheel 600. Further, the combination of the optics system 500 and the control system can be used to determine the distance between the central axis M of the measurement device 400 and the central axis D of the calibration wheel 600, which can be used to adjust the sharpener 200 to align the central axis M and the central axis D.

Using a calibration wheel 600 with curved reflective outer surface 604 to determine a linear distance may provide some benefits. For example, the angle of the reflected beam generated by the measurement device 400 is amplified relative to the movement of the calibration wheel 600 in the y-direction. This amplification may enhance the accuracy of the alignment system as small movements in the y-direction can result in large angles, enabling the skate blade 100 to be aligned with the grinding wheel 150 with a smaller margin of error. In another example, the curved reflective outer surface 604 may allow a less expensive sensor to be used in the measurement device 400 because the outer surface 604 causes the reflected beam to spread relative to the small linear distance, which provides for better measurement resolution. The curved reflective outer surface 604 also increases the accuracy of the alignment measurement because small differences in the y-position of the calibration wheel 600 are amplified relative to the position of the reflected beam on the sensor 510.

While FIG. 6H illustrates the components of the optics system 500 orientated in a particular manner, the position of the optics system 500 can vary between embodiments of the measurement device 400. Various mounting methods such as bolts, screws, fasteners, tape, and/or the like may be used to mount and position the components of the optics system 500 to the measurement device 400. As noted above, generally, the components of the optics system 500 are mounted/fixed to the frame 414. In some examples, the mounting system may give a user flexibility to adjust location and alignment of the components of the optics system 500 relative to each other.

The measurement device 400 includes a control system. The control system may include the electrical components of the measurement device 400. For example, the control system may include a central processing unit, one or more printed circuit boards (“PCBs”), one or more receiving coils, one or more power sources (e.g., batteries), one or more microprocessors, one or more storage systems, an accelerometer, a communication interface for short-range communication (e.g., Bluetooth communication, NFC communication, and the like), or long-range communication (e.g., WIFI connectivity and communication), etc. The components of the control system may be used to power the measurement indicators 409 and the sensor 510. In an embodiment where the measurement device 400 includes a display, such as an LED display, the control system may be configured to cause text or images to be displayed on the display. As explained further herein, the control system may also be configured to connect and transmit data to various other devices using wireless networking technology (e.g., Wi-Fi), Bluetooth, and/or the like. The accelerometer may be configured to monitor a position of the measurement device 400 and/or shock levels seen by the measurement device 400. For example, if the measurement device 400 is dropped or used is a rough or abusive fashion, the accelerometer may log these shock levels. This feature may provide a benefit of alerting the user when the measurement device 400 has experienced significant shock levels such that the optics system 500 may be damaged or misaligned.

In some embodiments, the measurement device 400 may be configured to align the skate blade 100 with the grinding wheel 150 without the use of the calibration wheel 600. For example, a similar reflective outer surface to the reflective outer surface 604 of the calibration wheel 600 could be integrated into a portion of the sharpener 200 or the grinding wheel 150 itself. For example, the measurement device 400 may be calibrated to interact with the arbor of the sharpener 200 or another component to determine when the measurement device 400 and the grinding wheel 150 are aligned. In some embodiments, when using the grinding wheel 150 for alignment with the measurement device 400, the grinding wheel 150 may include a similar outer surface geometry to the calibration wheel 600. For example, the grinding wheel 150 may include an outer surface with radiused portions and/or flat portions such that a reflected laser beam would be at an angle α relative to the sensor axis A when the central axis 152 of the grinding wheel 150 is not aligned with the central axis M of the measurement device 400.

In some embodiments, the calibration wheel 600 may include a sensor (e.g., the sensor 510) and the measurement device 400 may be configured to direct the beam of light at the sensor. In this case, the calibration wheel 600 may not require a reflective surface and the sensor of the calibration wheel 600 can be used to align the central axis D with the central axis M. For example, the sensor may be in communication with the calibration wheel 600 and can use the position of the receive laser spot to determine whether the measurement device 400 and the calibration wheel 600 are aligned.

FIGS. 9A and 9B illustrate schematic diagrams of a laser path generated using an embodiment of the optics system 500 at linear y-positions of the calibration wheel 600. For ease of explanation, only select components of the optics system 500 and measurement device 400 are illustrated. FIGS. 9A and 9B illustrate the optics system 500 and the calibration wheel 600 from a front view (i.e., aligned with the x-axis of the sharpener 200). The radiused reflective outer surface 604 of the calibration wheel 600 can results in a different angle of reflection a relative to the sensor axis A when the calibration wheel 600 is in different positions along the y-axis. As explained below, the measurement device 400 can use the angle of reflection to determine a linear y-position of the calibration wheel 600. For example, the software of the control system of the measurement device 400 analyzes the position of the returned laser spot on the sensor 510, thus determining the distance and direction the calibration wheel 600 must be adjusted to align the skate blade's 100 central axis 120 with the central axis 152 of the grinding wheel 150. Adjusting the calibration wheel 600 or the grinding wheel 150 may refer to the adjusting the grinding ring motor carriage of the sharpener 200, which causes the linear y-position of the grinding wheel 150 to change relative to the skate blade 100. Depending on the sharpener 200, this adjustment can be made manually, or the sharpener 200 may include an automated motor carriage that can be controlled by the sharpener 200 to adjust the linear y-position of the grinding wheel 150.

FIG. 9A illustrates schematic diagram 700. In diagram 700, the central axis M of the measurement device 400 (which is aligned with the laser beam axis B) is aligned with the central axis D of the calibration wheel 600. As such, the angle α is zero. As shown in FIG. 9A, the laser 502 generates a laser beam 512 that travels along the laser axis B towards the reflective outer surface 604 of the calibration wheel 600. After contacting the reflective outer surface 604 at the central axis D, a reflected laser beam 514 travels towards and through the lens 508 and a refracted laser beam 516 exits the lens 508. The refracted laser beam 516 travels towards and contacts a lower surface 518 at a laser spot 520 of the sensor 510. Because the central axis M of the measurement device 400 is aligned with the central axis D of the calibration wheel 600, the angle α is zero and the laser beam 512, reflected laser beam 514, and refracted laser beam 516 all travel along the sensor axis A. The sensor 510 and the control system use the laser spot 520 to determine the angle α and/or the y-position of the calibration wheel 600.

FIG. 9B illustrates schematic diagram 700′. In diagram 700′, the central axis M of the measurement device 400 (which is aligned with the laser beam axis B) is not aligned with the central axis D of the calibration wheel 600. As shown, the central axis D is too far in the positive y-direction. As such, the angle α is non-zero. As shown in FIG. 9B, the laser 502 generates a laser beam 512 that travels along the laser axis B towards the reflective outer surface 604 of the calibration wheel 600. After contacting the reflective outer surface 604 at first radiused portion 606, a reflected laser beam 514′ travels towards and through the lens 508 and a refracted laser beam 516′ exits the lens 508. The refracted laser beam 516′ travels towards and contacts a lower surface 518 at a laser spot 520′ of the sensor 510. Because the central axis M of the measurement device 400 is not aligned with the central axis D of the calibration wheel 600, the angle α is non-zero and the reflected laser beam 514 travel at the angle α relative to the sensor axis A. The sensor 510 and the control system use the laser spot 520 to determine the angle α and/or the y-position of the calibration wheel 600.

As noted above, in some examples, the sensor 510 is configured to determine the weighted center of mass of the laser spot (e.g., laser spot 520) received by the sensor 510. Depending on the y-position of the calibration wheel 600, the laser spot will enter/be received by the sensor 510 at different locations across a width of the sensor 510 (see e.g., FIGS. 9A and 9B). In the illustrated embodiment, when the laser spot is in the middle of the field of view of the sensor 510, the angle α is zero. When the laser spot is not in the middle of the field of view of the sensor 510, such as to the left or right of the sensor axis A, the angle α is non-zero. In some examples, software image processing may be used on the images captured by the sensor 510 to determine the weighted center of mass of the reflected laser light into the sensor. The weighted center of mass may then be used and/or calibrated to an actual angle α value (e.g., in radians or degrees) and/or a y-position of the calibration wheel 600.

In some examples, the optics system 500 within the measurement device 400 may be calibrated such that the y-position of the calibration wheel 600 can be accurately determined from the laser spot received by the sensor 510. In one example, the optics system 500 may be calibrated by mounting the measurement device 400 on the sharpener 200 or a calibration fixture which simulates the sharpener setup. The calibration wheel 600 may then be translated along the y-axis through a range of known linear positions along the y-axis while the laser 502 directs a laser beam (e.g., laser beam 512) at the calibration wheel 600 and the sensor 510 receives the laser spot while the sensor output is captured. Using this information, a regression (e.g., least squares fit) can be performed which will then yield a function that takes the sensor value(s) as inputs, and outputs an actual angle α value or y-position. This process can be performed after assembly of each measurement device 400, and the calibration stored in the memory of the control system for each individual measurement device 400. It is recognized that this calibration method is provided for example only and any other conventional laser/sensor calibration method could be used for the measurement device 400.

FIG. 10A illustrates a method 800 of using the measurement device 400 to center the central axis 152 of the grinding wheel 150 with the central axis of the skate blade 100. It is recognized that there are other embodiments of the measurement device 400 and method 800 which may exclude some of the steps shown and/or may include additional steps not shown. Additionally, the steps discussed may be combined, separated into sub-steps, and/or rearranged to be completed in a different order and/or in parallel.

The method 800 begins at block 802, when a user inserts an alignment component, such as a calibration wheel 600, in the sharpener 200. The alignment component may be in a nominal position (e.g., a pre-sharpening position) along the x-axis. In some embodiments, the user may use the sharpener 200 to move the alignment component to the previously stored zeroed location.

At block 804, the user places the measurement device 400 in the jaws 202 of the sharpener 200 in a measurement orientation. The measurement orientation is when the measurement device 400 is positioned such that the laser axis B is directed towards the alignment component. As noted above, the measurement device 400 may include alignment features (e.g., alignment members 435, 437) to assist with the orientation. The jaws 202 may be in the nominal position (e.g., a pre-sharpening position) along the x-axis.

At block 806, after the measurement device 400 and the alignment component are secured and positioned in the sharpener 200, the user may use the measurement device 400 to determine whether the central axis M of the measurement device 400 is aligned with the central axis D of the alignment component, as described above. The measurement device 400 can determine whether the measurement device 400 and the alignment component are in a state of operational alignment. For example, the user may use the power button 416 or another control button 412 to activate a measurement operation. As explained above with reference to at least FIGS. 6H, 8A, and 8B, the measurement device 400 may use a light emitting source, such as laser 502, to generate a laser beam that travels along the laser beam axis B through the filter 506. The laser beam travels towards and is reflected by the reflective outer surface 604 of the calibration wheel 600. The reflected laser beam then travels through the lens 508 and is received by the sensor 510. Once the sensor 510 receives the reflected laser beam, the control system determines the angle α between the reflected laser beam and the sensor axis A based on the received laser spot. In one example, the control system may analyze data from the sensor 510 and determine the weighted center of mass of the laser spot received by the sensor 510. For example, the weighted center of mass allows for the determination of the angle α and the linear y-position of the calibration wheel 600 relative to the measurement device 400.

When the calibration wheel 600 is nominally aligned with the measurement device 400, the angle α measured by the measurement device 400 will be zero (e.g., zero or calibrated zero based on an acceptable tolerance). Nominal alignment, as the term is used herein, refers to an ideal state of alignment between the central axis M of the measurement device 400 and the central axis D of the calibration wheel 600 that does not account for manufacturing tolerances and operational characteristics. Operational alignment, as the term is used herein, refers to a state of alignment where the central axis 152 of the grinding wheel 150 is co-planer with the central axis 120 of the skate blade 100, within an acceptable tolerance range. Manufacturing tolerances in the various devices may result in operational alignment, being at a non-zero angle α. As explained in the method 900 of FIG. 10B, the measurement device 400 can be recalibrated such that a new zeroed or nominal alignment for the measurement device 400 is at substantially the same position as the operational alignment, which may be at a non-zero angle α. To further clarify, the sensor 510 of the measurement device 400 can be recalibrated such that the center of mass position of the reflected beam on the sensor 510 is associated with the operational alignment of the grinding wheel 150 and the skate blade 100. When the calibration wheel 600 is not properly aligned with the measurement device 400, the angle α measured by the measurement device 400 will not be zero. The measured angle α can be used to determine the adjustment needed for the sharpening machine. For example, the control system of the measurement device 400 can determine how much and in which direction the calibration wheel 600 needs to be adjusted along the y-axis for proper alignment.

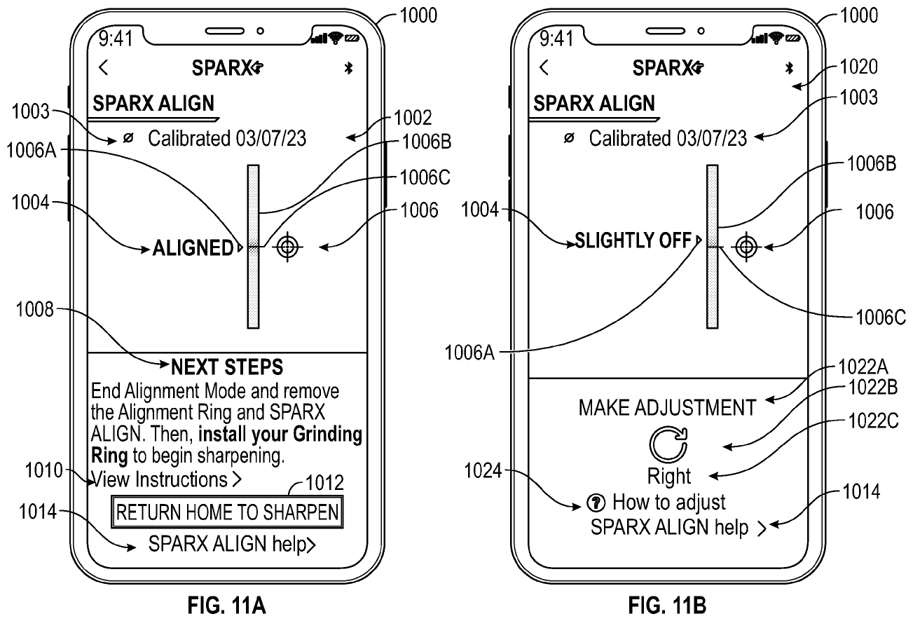

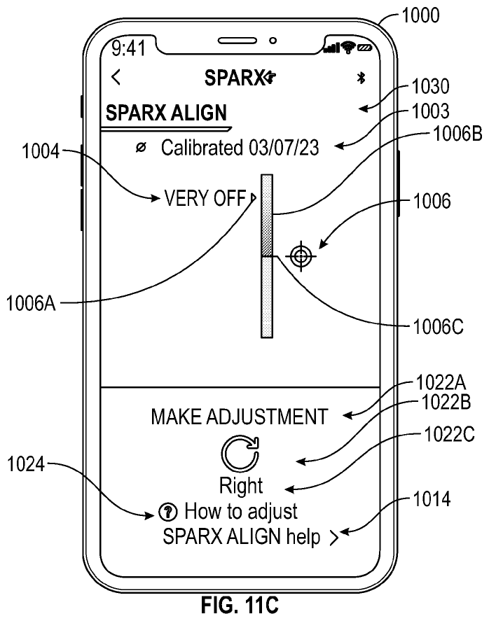

At block 808, the measurement device 400 outputs the measurement result based at least in part on the measurement data. The measurement result can include both a distance to adjust the calibration wheel 600 and a direction to adjust the calibration wheel 600 along the y-axis. In an embodiment where the measurement device 400 includes a display, the outputs may be displayed on the display of the measurement device 400. In some examples, the outputs may be transmitted to a software application associated with the measurement device 400 or a third-party application (see e.g., FIGS. 11A-11C). In some examples, the output(s) may be transmitted directly to a skate sharpening machine 200.

At block 810, the user can adjust the position of the calibration wheel 600 in the sharpener 200 based on the outputs from the measurement device 400. Depending on the type of skate sharpening machine the user is using, the sharpener may be adjusted in at least three different ways. Adjusting the sharpener refers to changing the y-position of the grinding wheel 150 or calibration wheel 600 (e.g., across the width of the skate blade 100) in the machine relative to a pre-set/pre-calibrated position. In a first example, the user may manually adjust the calibration wheel 600 using the measurement results. In a second example, the measurement device 400 may transmit the measurement data to a sharpener application (e.g., such as on a mobile computing device) and the adjustment information for the calibration wheel 600 can be displayed to the user via the sharpener application. For example, see at least FIGS. 11B and 11C. Based on the displayed adjustment information, the user can make the necessary adjustments to the sharpener manually. In a third example, the measurement device 400 may transmit the measurement data to the sharpener. For example, the measurement device 400 may transmit y-position adjustments of the calibration wheel 600 to a control system locally on the sharpener or the measurement device 400 may transmit the measurement data to a sharpener control system remote from the sharpener, which it turn can transmit the measurement data to the sharpener. In the third example, when the adjustment information is relayed wirelessly to the control system, one or more sharpening parameters (e.g., position of the calibration wheel 600) of the sharpener may be automatically adjusted based on the measurement data. For example, the control system may be configured to automatically determine the types of adjustments needed to correct the alignment of the sharpener based on the measurement data. This third example requires that the sharpener 200 includes a mechanism for automatically adjusting the position of the grinding wheel 150.

In some embodiments, the position of the grinding wheel 150 within the sharpener 200 is fixed in at least the y-direction, and the y-position of the jaws 202, which hold the skate blade 100, can be adjusted. In this type of system, the same three examples described above can be used, except that the y-position of the jaws 202 can be adjusted in the sharpener 200 relative to the fixed grinding wheel 150.

Optionally, the user can then replace the calibration wheel 600 with the grinding wheel 150 and the measurement device 400 with the skate blade 100 and perform a sharpening operation. As explained further with reference to the method 900 of FIG. 10B, the outputs of the measurement device 400 can be used to calibrate the sharpener 200 to produce even edges 116, 118 on the skate blade 100.

In some embodiments, the measurement device 400 is configured to communicate with the sharpener 200 (e.g., via Bluetooth) while the measurement device 400 takes measurement. In some embodiments, the measurement device 400 takes a plurality of measurements while the calibration wheel 600 is translated along the x-axis within a certain range of the nominal location. In this example, the measurement device 400 may determine which x-position of the calibration wheel 600 is optimal for alignment measurements and instruct the sharpener 200 to move the calibration wheel 600 to the that positions. In some embodiments, one or both of the measurement device 400 and sharpener 200 may store this locations for future alignment operations (e.g., the method 800).

In some embodiments, the sharpener 200 may rotate the calibration wheel 600 while the measurement device 400 takes a plurality of measurements. In this example, the measurement device 400 may determine which angular position of the calibration wheel 600 is optimal for alignment measurements and instruct the sharpener 200 to move the calibration wheel 600 to this angular position. For example, if the calibration wheel 600 had a position of the reflective outer surface 604 that was scratched, dirty, or otherwise damaged, some angular positions of the calibration wheel 600 may produce more accurate results. In some embodiments, the measurement device 400 may average the results of the measurements while the calibration wheel 600 is rotated.

FIG. 10B illustrates a method 900 of calibrating a skate sharpening machine based on measurement data generated by the measurement device 400. It is recognized that there are other embodiments of the measurement device 400 and method 800 which may exclude some of the steps shown and/or may include additional steps not shown. Additionally, the steps discussed may be combined, separated into sub-steps, and/or rearranged to be completed in a different order and/or in parallel.

The method 900 begins at block 902, when a user aligns the sharpener 200 with the measurement device 400 and calibration wheel 600 as described in the method 800 of FIG. 10A.

At block 904, the user uses the sharpener 200 to sharpen the skate blade 100. For example, the user can replace the calibration wheel 600 with the grinding wheel 150 and the measurement device 400 with the skate blade 100 and use the sharpener 200 to translate the grinding wheel 150 along the bottom of the skate blade 100 along the x-axis.

At block 906, the user may use a separate edge checking device to measure the edges 116, 118. For example, the user can perform an edge check using one of the various systems and devices described and/or illustrated in PCT Patent Application No. PCT/US2023/018655, filed Apr. 14, 2023, titled “DEVICE AND METHODS FOR MEASURING AND ANALYZING GEOMETRY IN ICE SKATE BLADES”, the entire contents of which are hereby incorporated by reference. For example, the edge checking device can generate measurement data associated with the skate blade. The measurement data can include the delta height H of the edges 116, 118 of the skate blade 100. If the edges 116, 118 are even, the user can confirm that the measurement device 400 is correctly calibrated based on the current position of the grinding wheel 150, and the method 900 can terminate. If the edges 116, 118 are uneven, the method proceeds to block 908.

At block 908, the user may use the measurement outputs from the edge checking device to adjust the sharpener 200. For example, the edge checking device can indicate a required linear y-position and direction to adjust the grinding wheel 150 in order to bring the sharpener 200 into operational alignment. Any of the examples described with reference to block 810 of the method 800 can be used to adjust the calibration wheel 600 based on the edge measurement using the edge checking device.

At block 910, once the sharpener 200 is adjusted, the user may recalibrate the measurement device 400. Recalibration can refer to resetting the measurement device's 400 factory nominal or default settings. For example, the recalibration can modify the alignment readings of the measurement device 400 based on a reading from the calibration wheel 600. To recalibrate, the user may re-insert the measurement device 400 and the calibration wheel 600 into the sharpener 200. The user may then perform the method 800 of FIG. 10A to generate measurement results. Because the user has adjusted the y-position of the calibration wheel 600 at block 908 after the zero angle α was measured at block 902, the measurement device 400 will indicate that the calibration wheel 600 is misaligned. The user can recalibrate or zero the measurement device 400 based on the new position of the calibration wheel 600. For example, the user may use a control button 412 to recalibrate the measurement device 400 to define the current position of the calibration wheel 600 as the alignment position.

In some embodiments, the measurement device 400 can be recalibrated without performing the steps of block 908 and 910 (e.g., without reinserting the measurement device 400 to recalibrate). The required adjustment of the grinding wheel 150 determined by the edge checking device can be input or transmitted to the measurement device 400. The measurement device 400 can use the calculated adjustment to estimate a revised center of mass position of the reflected laser on the sensor 510 corresponding to correct alignment and set this center of mass position as the zeroed alignment position.

In some embodiments, the user can use the software application on the user device 1000 to communicate with the measurement device 400 and/or the sharpener 200 to complete the method 900. For example, when one or both the measurement device 400 and the edge checking device are in communication with the user device 1000, the user device 1000 can coordinate the recalibration process without requiring the user to complete the steps of blocks 908 and 910.

Use of the measurement device 400 to align the skate blade 100 and the grinding wheel 150 may provide a number of advantages of existing alignment systems, such as the optical alignment tool 210. For example, the measurement device 400 may provide a more accurate measurement due in part to the use of the laser 502 and sensor 510 as opposed to using human vision. In another example, the measurement device 400 may improve the adjustment process of the skate sharpening machine based on easy to understand adjustment instructions generated by the measurement device 400 or the sharpener application.

### C. Measurement Device Associated Software

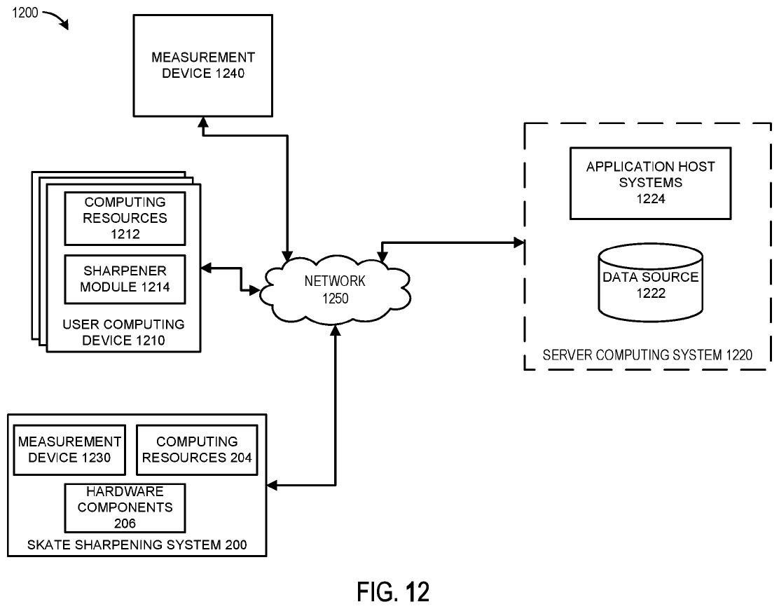

As noted above, in some examples, the measurement devices described herein (e.g., measurement device 400) may be configured to interact with additional devices such as, for example, user devices, skate sharpening machines, third party platforms, and/or the like. In some examples, measurement devices, user devices, skate sharpening machines, and third-party platforms may be configured to communicate over a network. In some examples, the network may comprise one or more networks, including, for example, a local area network (LAN), wide area network (WAN), WI-FI, and/or the Internet, for example, via a wired, wireless, or a combination of wired and wireless, communication links. The network can facilitate communication between the measurement devices, user devices, skate sharpening machines, and third party platforms, and/or additional devices. In addition to or alternatively to communication over the network, in some examples, the various devices may be configured to communicate with each other using short-range communication, such as near field communication (NFC) or Bluetooth, and/or the like. User devices, such as user device 1000 described below, may include personal computers, laptop computers, phones (e.g., smart phones), tablets, smart watches, and/or the like. The third-party platforms may comprise one database or multiple databases. The third-party platforms may be controlled by a database management system. The third-party platforms may be configured to store sharpening data, sharpening machine data, skate data, information about specific users, and/or the like. An example operating environment is illustrated in FIG. 12.

FIGS. 11A-11C illustrate example graphical user interfaces being presented on a user device 1000. The user interfaces are associated with a software application related to the measurement device 400 being run on the user device 1000. For example, a user may use the user device 1000 with the associated application to wirelessly communicate with the measurement device 400. The user interfaces shown in FIGS. 11A-11C illustrate alignment pages that may be generated after a user performs the method 800 of FIG. 10A. For example, after the user completes the method 800, the measurement device 400 may transmit the measurement data to the user device 1000 for presentation of the results via the software application. The software application may be configured to receive and display an output associated with the measurement data, such as alignment data received from the measurement device 400. In another example, the software application may automatically receive alignment data from the measurement device 400 when the measurement device 400 and a computing device using the software application are in short range communication protocols, such as near field communication, or, for example, operating on the same local area network. While the user device 1000 illustrated in FIGS. 11A-11C is a smart phone, it is recognized that any other user computing device can be used to run the application.

FIG. 11A illustrates a first user interface 1002 being presented on the user device 1000. The first user interface 1002 may include a calibration date 1003. The calibration date 1003 indicates the last time the measurement device 400 was calibrated. For example, the measurement device 400 may have been calibrated using the method 900 of FIG. 10B.

The first user interface 1002 may include an alignment indicator 1004 and an alignment graphic 1006. The alignment indicator 1004 indicates whether the measurement device 400 is in a state of operational alignment with the alignment component (e.g., calibration wheel 600 or grinding wheel 150) based on the performed method 800. The alignment indicator 1004 may indicate whether the systems are aligned. misaligned, and/or provide an indicator of a degree of misalignment. In the illustrated example, the measurement device 400 is in a state of operational alignment with the alignment component and the alignment indicator 1004 provides a textual indication of the alignment status.

The alignment graphic 1006 can provide a visual indication of the alignment. For example, the alignment graphic 1006 may include a visual indicator 1006A (e.g., a triangle) that represents the central axis M of the measurement device 400 and a bar 1006B that represents the alignment component with a central line 1006C representing the central axis D, or vice versa. In the illustrated example, because the systems were aligned, the triangle 1006A is aligned with the central line 1006C of the bar 1006B.

Based on the alignment determination, the first user interface 1002 may include instructions 1008 (via alphanumeric text or other graphical indicators) for the user. For example, the instructions 1008 may indicate to the user to end Alignment Mode and remove the measurement device 400 and the calibration wheel 600 before returning the grinding wheel 150 to the sharpener 200 for a sharpening operation. The first user interface 1002 may also include an instructions link 1010. The instructions link 1010 may be selectable by the user to provide more detailed instructions for the subsequent steps. In some examples, by selecting the link (e.g., touch the screen on a touch screen device, clicking the link with a cursor, etc.), the software application may generate one or more additional user interfaces that include information about the selected topic. In another example, selecting the link may generate a web link and/or automatically open a web page related to the topic, such as, for example, directing the user to a web page associated with the software application.

The first user interface 1002 may include further user selectable links such as a home link 1012 and a help link 1014. The home link 1012 may be selected to return the user to the home page of the software application. The help link 1014 may be selected to generate further information and help for the user related to the measurement device 400, calibration wheel 600, software application, and/or the like.

FIG. 11B illustrates a second user interface 1020 being presented on the user device 1000. The second user interface 1020 may include the calibration date 1003, the alignment indicator 1004, and the alignment graphic 1006. In this case, the measurement device 400 was misaligned with the calibration wheel 600, so the alignment indicator 1004 textually indicates that the systems are not aligned. Because the alignment was only slightly off, the alignment indicator 1004 may read “slightly off”. Similarly, because the systems were misaligned, the triangle 1006A is slightly off from the central line 1006C of the bar 1006B.

When the calibration wheel 600 and the measurement device 400 are misaligned, the user device 1000 may include instructions and visual indicators to assist the user in adjusting the position of the grinding wheel 150 for correct alignment. For example, the second user interface 1020 may include a text 1022A that indicates to the user that they need to make an adjustment. The second user interface 1020 may also include a graphic adjustment indicator 1022B and a textual adjustment indicator 1022C. The graphic adjustment indicator 1022B can be a graphic illustrating the adjustment direction required. The adjustment indicator 1022C can be text that indicates the adjustment direction (e.g., left, or right).

The second user interface 1020 may also include an adjustment help link 1024 and the help link 1014 that can be selectable by the user to generate more detailed instructions related to adjusting the sharpener 200. In some examples, by selecting the links (e.g., touch the screen on a touch screen device, clicking the link with a cursor, etc.), the software application may generate additional user interfaces that include information about the selected topic. In another example, selecting the link may generate a web link and/or automatically open a web page related to the topic, such as, for example, directing the user to a web page associated with the software application.

FIG. 11C illustrates a third user interface 1030 being presented on the user device 1000. The third user interface 1030 may include the calibration date 1003, the alignment indicator 1004, and the alignment graphic 1006. In this case, the measurement device 400 was misaligned with the calibration wheel 600, so the alignment indicator 1004 textually indicates that the systems are not aligned. Because the alignment was very off, the alignment indicator 1004 may read “very off”. Similarly, because the systems were misaligned, the triangle 1006A is shown at a distance from the central line 1006C of the bar 1006B. The third user interface 1030 may also include the text 1022A, graphic adjustment indicator 1022B, textual adjustment indicator 1022C, adjustment help link 1024, and help link 1014.

### D. Automated Alignment

Skate blades are not always flat in the x-z plane (e.g., see FIG. 2A). In fact, most blades will have some amount of warping from heel to toe because of stresses from the manufacturing process, warpage in the skate blade holder on the boot of the skate which bends the blade when it is inserted into the skate blade holder, and/or other reasons. Warped skate blades (non-flat blades) present unique issues in the skate-sharpening process. For example, in some skate sharpening systems that require manual alignment, the manual alignment step is performed by using the jaws 202 to secure the skate blade 100 in the skate sharpener 200 and aligning the grinding wheel 150 to one or more (typically three or less) arbitrary points along the length of the blade 100. This manual alignment process assumes that the blade 100 is “flat” enough that aligning the grinding wheel 150 to one or more specific locations along the length of the blade 100 will ensure that the grinding wheel 150 is sufficiently centered on the entire length of the blade 100. However, this assumption can be inaccurate, and the grinding wheel 150 is not sufficiently centered along the entire length of the blade 100. Most skate blades 100 will have enough variation in the flatness that the centering of the grinding wheel 150 on the skate blade 100 to several discrete points along its length can still cause uneven sharpening.

The combination of the measurement device 400 and calibration wheel 600 described above represent significant improvements in the field of aligning skate blades 100 and grinding wheels 150. For example, this system removes the human error from the alignment process. Additionally, this system accounts for tolerances in machines through recalibrations processes, such as the method 900 of FIG. 10A. However, this system may not account for warping along the length of the blade. As such, a system configured to provide real-time continuous alignment (also referred to herein as continuous alignment) of the central axis 152 of the grinding wheel 150 with the blade thickness 122 of the skate blade 100 during a sharpening operation may provide certain benefits.

In some embodiments, the systems described herein can be used to measure the skate blade 100 as part of a pre-sharpening setup step and/or as part of a continuous real-time measurement that allows for continuous alignment adjustment during the sharpening process. Measuring the skate blade 100 directly can be advantageous for several reasons. In one example, measuring the skate blade 100 directly eliminates the need for performing setup alignment steps using additional devices. In another example, measuring the skate blade 100 directly eliminates reliance on calibrations features and machining tolerances. As such, a more accurate measurement of the required alignment adjustment can be provided.

In some embodiments, automated alignment, whether a one-time setup step or a real-time measurement and adjustment during sharpening, can provide an advantage by utilizing data collected to continually improve the accuracy, precision, and/or time for sharpening with automated adjustment. The data may be collected for implementation of deep learning, machine learning, artificial intelligence algorithms, and/or the like,

a. Automated Setup Alignment

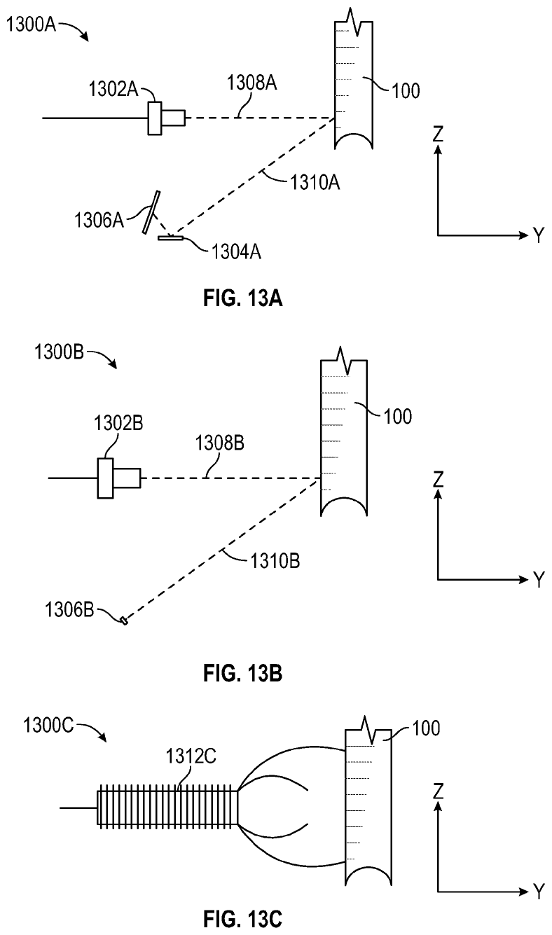

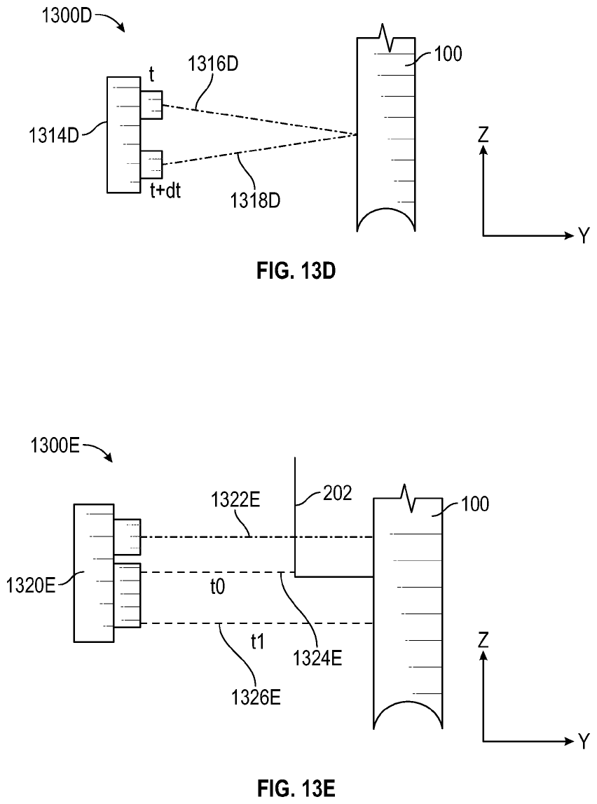

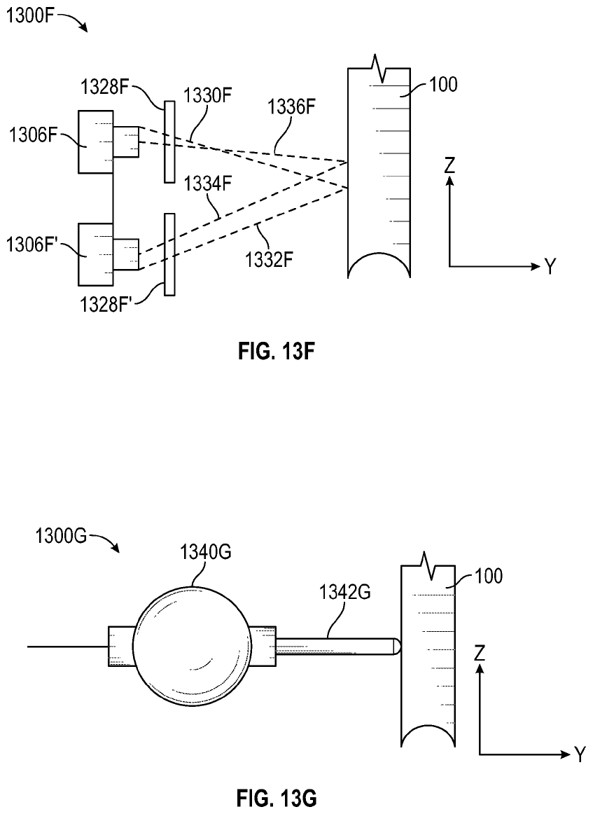

An automated setup alignment system may be used with a skate sharpening system, such as the sharpener 200 described above. In some embodiments, the sharpener 200 may require that the y-position of one or both of the jaws 202 (e.g., securing the 100) and the grinding wheel 150 can be changed as the grinding wheel 150 is translated in the x-direction. In some embodiments, the automated setup alignment system can be used with one or more of the distance measuring systems described in FIGS. 13A-13G (collectively referred to as distance measuring systems 1300). The distance measuring systems 1300 (also referred to as measurement devices) can be mounted to or integrated into the sharpener 200. In some cases, the distance measuring systems 1300 may be separate devices that can be inserted by the operator into the sharpening systems 200. In some cases, the distance measuring devices 1300 can be inserted into the jaws 202 of the sharpener 200.

While the distance measuring systems of FIGS. 13A-13G are shown measuring the distance to the skate blade 100, these systems could be used to measure the distances to components of the sharpener 200, such as the grinding wheel 150 or the jaws 202. Additionally, distance measuring systems of FIGS. 13A-13G may be configured to measure one or more calibration fitments placed along the length of the skate blade 100 or the jaws 202 instead of the actual skate blade 100 itself. In some cases, it may be desirable to measure the distance to the calibration fitments because the calibration fitments can have properties (e.g., reflective surfaces) that improve the functions of the distance measuring systems 1300, particularly when a light emitting source is used. While various distance measuring devices/sensors are identified, it is recognized that other known devices/sensors could also be used. While FIGS. 13A-13G illustrate measurement of a distance to the skate blade 100 from one side, the sharpener 200 may include one or more distance measuring systems 1300 positioned on either side of the skate blade 100. In this arrangement, the central axis 120 of the skate blade 100 can be determined based on the measured distances to each side of the skate blade 100. Similarly, for determining the central axis 152 of the grinding wheel 150, one or more distance measuring systems 1300 can be positioned on either side of the grinding wheel 150, such that the position of the central axis 152 can be determined based on the measured distances.

Parts, components, features, and/or elements of distance measuring systems in FIGS. 13A-13G described below that can function the same or similarly across various implementations are identified using the same reference numerals with a different letter added after the reference numerals. Differences between the various implementations are discussed herein. The distance measuring systems 1300 that include a light emitting source may include various additional components, such as apertures and/or optical lens(es) that can be used for focusing, collimating, magnification telecentric imaging, and/or the like.

FIG. 13A illustrates a distance measuring system 1300A. The distance measuring system 1300A may include a light emitting source 1302A, a reflective surface 1304A, and a sensor 1306A. The distance measuring system 1300A is configured to measure a distance to the skate blade 100. The light emitting source 1302A may be any suitable light emitting source that can generate a beam of light or a laser beam. In some examples, it may be desirable for the light emitting source 1302A to be a collimated laser. A collimated laser can be configured to generate a collimated beam of light that propagates in homogeneous mediums (e.g., air) with a low beam divergence. Low beam divergence may be desirable so that the beam radius does not undergo significant changes within moderate propagation distances. The reflective surface 1304A can be any reflective surface, such as a mirror. The sensor 1306A may be any suitable sensor for receiving the beam of light generated by the light emitting source 1302A. For example, the sensor 1306A may be a position sensitive detector, a charge coupled device, a complementary metal-oxide semiconductor device, a photoelectric proximity sensor, and/or the like.

In operation, the light emitting source 1302A generates a beam of light 1308A that is reflected off the skate blade 100, such that a reflected beam of light 1310A travels towards the reflective surface 1304A and is reflected into the sensor 1306A. In some embodiments, the reflected beam 1310A may be reflected directly into the sensor 1306A. When the sensor 1306A receives the reflected beam 1310A, the light imaged onto the sensor 1306A from the beam, referred to as the laser spot, can be converted into electrical signals. The type of electrical signal may be dependent on the electrical design specification for the particular sensor 1306A used. The electrical signal may then be used to create an “image” of the light on the sensor 1306A. The sensor 1306A may be configured to determine the distance from the light emitting source 1302A to the skate blade 100 based on the electrical signal.

FIG. 13B illustrates a distance measuring system 1300B. The distance measuring system 1300B may include a light emitting source 1302B, and a sensor 1306B. The distance measuring system 1300B is configured to measure a distance to the skate blade 100. The sensor 1306B may be a photo diode. For example, the sensor 1306B may be a light-sensitive semiconductor diode that produces current when it absorbs photons. The distance measuring system 1300B may function in the same manner as the distance measuring system 1300A except that the distance measuring system 1300B may not include a reflective surface.

FIG. 13C illustrates a distance measuring system 1300C. The distance measuring system 1300C may include a proximity sensor 1312C. The proximity sensor 1312C may be an inductive proximity sensor, capacitive proximity sensor, infrared proximity sensor, and/or the like. The distance measuring system 1300C is configured to determine the distance from the proximity sensor 1312C to the skate blade 100.

FIG. 13D illustrates a distance measuring system 1300D. The distance measuring system 1300D may include a sound based proximity sensor 1314D (e.g., an ultrasonic proximity sensor). The sound based proximity sensor 1314D is configured to generate high-frequency sound waves 1316D (e.g., ultrasonic) at time t via a transducer. The high-frequency sound waves 1316D contact the skate blade 100 and the reflected waves 1318D are received via a receiver at time t+dt. The sound based proximity sensor 1314D is configured to determine the distance to the skate blade 100 based on the time it takes for the ultrasonic waves to travel to the skate blade 100 and back to the sound based proximity sensor 1314D (e.g., the time dt).

FIG. 13E illustrates a distance measuring system 1300E. The distance measuring system 1300F may include a sensor 1320E, such as a LiDAR proximity sensor. The sensor 1320E can include a transmitter and a receiver. As shown, the distance measuring system 1300E can measure a distance to the jaws 202 holding the skate blade 100 and the skate blade 100 itself. The sensor 1320E may transmit a laser beam 1322E that contacts both the jaws 202 and the skate blade 100. The laser beam 1322E may be reflected off of the jaws 202 and a reflected beam 1324E may be returned to the receiver of the sensor 1320E at time to. Similarly, the laser beam 1322E may be reflected off of the skate blade 100 and a reflected beam 1326E may be returned to the receiver of the sensor 1320E at time t1. Based on the received reflected beams 1324E, 1326E, the sensor 1320E can determine the distance to the jaws 202 and the skate blade 100.

FIG. 13F illustrates a distance measuring system 1300F. The distance measuring system 1300F may include a first sensor 1306F, a second sensor 1306F′, a first lens 1328F, and a second lens 1328F′. The first and second sensors 1306F, 1306F′ may be CMOS sensors, CCD sensors, and/or the like for stereo vision distance detection. The lens 1328F, 1328F′ may be optical lens, such as the optical lens described herein. The first sensor 1306F may transmit a first beam 1330F via a transmitter that travels through the first lens 1328F and contacts the skate blade 100. The first beam 1330F may be reflected such that a first reflected beam 1332F travels through the second lens 1328F′ and is received by the second sensor 1306F′ via a receiver. Similarly, the second sensor 1306F′ may transmit a second beam 1334F via a transmitter that travels through the second lens 1328F′ and contacts the skate blade 100. The second beam 1334F may contact the skate blade 100 as a different location than the first beam 1330F. The second beam 1334F may be reflected such that a second reflected beam 1336F travels through the first lens 1328F and is received by the first sensor 1306F via a receiver. The first and second sensors 1306F, 1306F′ may be configured to determine the distance to the skate blade 100. Using two sensors may provide a benefit of allowing the distance to be averaged based on the readings of the two sensors. In another example, using two sensors may provide a benefit of allowing the distance measuring system 1300F to measure distances to two different objects or different locations on the same object.

FIG. 13G illustrates a distance measuring system 1300G. The distance measuring system 1300G may include a mechanical indicator 1340G. The mechanical indicator 1340G may include a pointer 1342G. The pointer 1342G is configured to contact the skate blade 100 and may travel along the length of the skate blade 100 as the skate blade 100 is moved in the x-direction. Alternatively, the mechanical indicator 1340G can be translated in the x-direction such that the pointer 1342G is translated along the length of the skate blade 100. Based on the position of the pointer 1342G relative to the mechanical indicator 1340G, the distance to the skate blade 100 can be determined.

In some embodiments, the distance measuring system 1300G, which uses physical contact to measure a distance, may be combined with one or more of the non-contact distance measuring systems 1300. For example, the distance measuring system 1300G can be used to measure the distance to the skate blade 100 and the non-contact distance measuring system(s) 1300 can be used to measure a distance to a portion of the distance measuring system 1300G. The measured portion of the distance measuring system 1300G may be enclosed and protected from contamination to improve the measurement accuracy. In this arranged, the distance measuring system 1300G can be displaced by the skate blade 100 during measurement (e.g., when the skate blade 100 is inserted into the jaws 202) and the displacement of the distance measuring system 1300G can be measured by the one or more distance measuring systems 1300.

The distance measuring systems 1300 can be placed in a position on a skate sharpening system 200 in an arrangement that enables visibility to the calibration fitments. In some cases, this arrangement can provide feedback to a user manually adjusting the alignment of the skate sharpening system 200. In some cases, this arrangement can provide feedback to a control system of the skate sharpening system 200, which can process data received from the distance measuring systems 1300 and adjust the alignment of the skate blade 100 and/or the grinding wheel 150 automatically. In some embodiments, the feedback data (e.g., images and/or sensor data) generated by the distance measuring systems 1300 can be transmitted to a computing device for processing (e.g., the user device 1000 running the sharpening application described herein), and the computing device can determine adjustments to the alignment. The computing device may output alignment instructions to a user interface of the computing device such that a user operating the skate sharpening system 200 could then make manual adjustments to the alignment. The computing device may communicate alignment adjustment instructions to the control system of the skate sharpening system for automated alignment. The computing device may be communicatively connected to the skate sharpening system 200 using wired or wireless communication interfaces and/or protocols, as described above. In some embodiments, one or both of the distance measuring systems 1300 and the sharpener 200 may be communicatively connected to a remote computing device, such as a server or a user device (e.g., the user device 1000) executing a software application (e.g., an app running on the user device 1000). The remote computing device can be used to relay communications between the distance measuring systems 1300 and the sharpener 200 and vice versa.

In the automated alignment system, the distance measuring systems 1300 can be used to improve alignment by providing feedback during manual alignment of the skate sharpening system 200. In some cases, the one or more calibration fitments can include at least a first fitment and a second fitment. The first fitment can be associated with a securing component, such as the jaws 202 of the sharpener 200. For example, the first fitment can be part of, removably coupled to, or positioned within the skate sharpening system 200 such that the first fitment can be used to align the jaws 202. The second fitment can be associated with a skate sharpening arbor. The skate sharpening arbor can support the grinding wheel 150. The second fitment can be part of, removably coupled to, or positioned within the skate sharpening system 200 such that the second fitment can be used to align the skate sharpening arbor. The distance measuring systems 1300 can then be used to generate alignment feedback data (e.g., an image, a numeric representation of alignment/misalignment, etc.) between the first fitment and the second fitment. The alignment feedback can be output to a display for a user (e.g., on a display on the skate sharpener 200 or on a display on the computing device, etc.). The alignment feedback data can provide an indication of a level of misalignment between the first fitment and the second fitment. The alignment feedback data can be updated during alignment (e.g., updating an image of the alignment components). For example, a user can begin making alignment adjustments, consult the updated image to check alignment, make further alignment adjustments, and so forth. In some embodiments, the image may be presented in real time. In other embodiments, the image may be presented with a delay. In some embodiments, a calibration line (or other alignment indicator) may be added to the arbor, such that it is configured to line up with a calibration line (or other alignment indicator) that is mounted in or on the jaws 202. In some embodiments, the alignment indicator can be a virtual alignment indicator that is programmatically added to the image output to the user. The virtual alignment indicator can be generated based on an analysis of the first and/or second fitments.

In some embodiments, feedback from distance measuring systems 1300 can be used by a control system of the sharpener 200 to programmatically perform an alignment operation on the skate sharpening system sharpener 200. For example, the distance measuring systems 1300 can be used to generate feedback data, such as an image, that can be analyzed by the control system to detect the level of misalignment between the first fitment and the second fitment. The control system can use one or more algorithms based on the feedback data to determine adjustments necessary to align the central axis 152 of the grinding wheel 150 with the central axis 120 of the skate blade 100. In some embodiments, the control system may use image processing algorithms in real time to move the grinding wheel 150 (e.g., by moving the arbor such that the grinding wheel 150 moves in the y-direction) until it is properly aligned. The alignment process may be initiated directly on the skate sharpening system 200. In some embodiments, the alignment process may be initiated by the mobile computing device, such as the user device 1000, in communication with the skate sharpening system 200. In some embodiments, the control system can implement open loop or closed loop control during the alignment process. Measurements may be taken by the distance measuring systems 1300 continuously, or at discrete points, such as after the grinding wheel has completed a pass. In some embodiments a machine learning algorithm can be used to improve the alignment process based on previous alignment operations. For example, the machine learning process can be used to identify and learn micro-adjustments that may be required in the control loop.

In some embodiments, automated setup alignment system may not include the one or more calibration fitments. For example, the distance measuring systems 1300 can be configured to determine one or both of the central axis 152 of the grinding wheel 150 and the 120 of the skate blade 100. Using the feedback from the distance measuring systems 1300, the central axis 152 of the grinding wheel 150 and the central axis 120 of the skate blade 100 can be aligned manually or automatically prior to commencing an operation on the skate sharpening system 200. Some non-limiting examples for determining the centerline of the skate blade include identifying a midplane between the two faces of the skate blade, measuring the delta height H of the skate blade 100 following a sharpening operation, and/or the like. A non-limiting example for determining the centerline of the grinding wheel 150 includes identifying a midplane between the two faces of the grinding wheel 150. Centerline detection for the skate blade 100 and the grinding wheel 150 are described further below with reference to an automated real-time alignment system. The centerline of the grinding wheel or skate blade can be generally referred to as the center location. In some embodiments, the centerline detection methods may be applicable to automated setup alignment.

In some embodiments, the sharpener 200 may include one or more encoders, for example, optical encoders, magnetic encoders, and/or the like. The encoders can be configured provide feedback to the skate sharpening system's 200 control system. The encoders may be positioned between two components of the sharpener 200. The encoder may be used to provide feedback related to the position of an adjustable component of the skate sharpening system 200, such as the arbor, the grinding wheel 150, the jaws 202, and/or the like. In one example, an encoder may be coupled to a portion of the carriage of the sharpener 200 (e.g., the carriage adjustment knob) to provide positional feedback in the x-direction relative to the rails of the sharpener 200. In another example, an encoder may be coupled to the motor arm of the sharpener 200 to provide positional feedback in the z-direction relative to the sharpener 200.

b. Automated Real-Time Alignment

As described above, when performing an operation on a skate sharpening system (e.g., the sharpener 200), such as, for example, sharpening or profiling the skate blade 100, proper alignment is essential for ensuring the operation is properly performed. In some embodiments, the sharpener 200 may include an automated real-time alignment system. The automated real-time alignment system may eliminate the need for a setup alignment process (e.g., using the measurement device 400 and calibration wheel 600 of FIGS. 6A-8B). In some embodiments, the automated real-time alignment system may eliminate the need for the setup alignment process (either automated or manual). In other embodiments, an automated real-time alignment system may allow and/or require the setup alignment process to be performed.

In some embodiments, the automated real-time alignment system of the sharpener 200 may include one or more of the distance measuring systems 1300. The distance measuring systems 1300 can be mounted to or integrated into the sharpener 200. In some cases, the distance measuring systems 1300 may be separate devices that can be inserted by the operator into the sharpening systems 200. In some cases, the distance measuring devices 1300 can be inserted into the jaws 202 of the sharpener 200. The automated real-time alignment system can include an alignment component that can be configured to adjust the position of the grinding wheel 150. The adjustment may be performed by a motor/actuator of the sharpener 200 and controlled by the control system of the skate sharpening system 200.

The automated real-time alignment system can be configured to determine the central axis 120 of the skate blade 100 prior to the grinding wheel 150 initiating contact with skate blade 100. The automated real-time alignment system can also be configured to determine the central axis 152 of the grinding wheel 150. The central axes 120, 152 of the skate blade 100 and grinding wheel 150 can be determined using one or more of the distance measuring systems 1300 described above. In some embodiments, the grinding wheel 150 is fixed within the skate sharpening system 200 (as opposed to, for example, a skate or skate blade), and the central axis 152 of the grinding wheel 150 may be determined at a previous calibration step.

To determine the position of the grinding wheel 150, the automated real-time alignment system can use one or more of the distance measuring systems 1300. In some cases, the automated real-time alignment system may use an alignment system including a calibration system (e.g., the measurement device 400 and the calibration wheel 600) to align the skate blade 100 with the grinding wheel 150. In some embodiments, the automated real-time alignment system can rely on the manufacturing and assembly tolerances of the sharpener 200 to have a known, fixed location of the central axis 152 of the grinding wheel 150 relative to one or more sensors, such as the sensors of the distance measuring systems 1300.

Following the determination of the central axis 152 of the grinding wheel 150, the position of the grinding wheel 150 (or conversely the skate blade 100) may then be adjusted in the y-direction by the automated real-time alignment system using feedback data from the sensor to center the grinding wheel's 150 central axis 152 to the central axis 120 of the skate blade 100 before the grinding wheel 150 initiates contact with the skate blade 100. In some embodiments, this adjustment may be the only adjustment made prior to performing a skate sharpening operation.

As described herein, during the sharpening process, before the grinding wheel 150 initiates contact with the skate blade 100, the location of the skate blade 100 relative to the sharpener 200 may be determined by the one or more sensor(s). Knowing the positional information of the grinding wheel 150 relative to the sensor(s) coordinate system (as determined by one of the options described herein), the Y location of the grinding wheel 150 may be adjusted to center the grinding wheel 150 to the central axis 120 of the skate blade 100.

The control system of the automated real-time alignment system may implement a control algorithm to control the mechanical components of the sharpener 200 (e.g., motor/actuator of the grinding wheel 150) to allow for real time Y location adjustment during a sharpening operation based on real time feedback of the sensor(s) that relay the location of the central axis 120 of the skate blade 100. The control algorithm and mechanical components of the sharpener 200 may allow for movement of the grinding wheel 150 in the y-direction during a sharpening operation (while grinding) without causing side loads on the grinding wheel 150 and skate 100. In one example, the central axis 120 of the skate blade 100 may be determined by the sensor(s) of the distance measuring systems 1300 by, for example, finding the midplane between the two faces of the skate blade 100. In another example, the central axis 120 of the skate blade 100 may be determined by, for example, using a laser or similar imaging device to measure the delta height H of the edges 116, 118 of the skate blade 100 following one or more sharpening passes, which could then be used to determine how far off center the grinding wheel 150 is from the skate blade 100. In some embodiments, it may be preferable that the automatic alignment process (i.e., Y adjustment) be performed immediately before grinding occurs. The alignment process may be performed as a one-time adjustment for each skate. The automatic alignment process can take into account various additional factors, such as manufacturing, assembly, and setup of the sharpener 200.

In some embodiments, the automated real-time alignment system may be configured to continuously monitor the position of the skate blade 100 relative to the grinding wheel 150 as the grinding wheel 150 traverses the entire length of the skate blade 150 (in the x-direction). As such, the position of the grinding wheel 150 may be automatically adjusted by the automated real-time alignment system as required to ensure that the central axis 152 of the grinding wheel 150 is aligned with blade thickness 122 of the skate blade 100 along the entire length of the skate blade 100. Automated grinding wheel 150 positional adjustments may allow for the system to compensate for variations in flatness and/or deviations in thickness of the skate blade 100. Thus, the system can produce even edges 116, 118 at all points along the length of the skate blade 100, regardless of flatness variation, blade thickness and/or machine and clamping variation. In some embodiments, the grinding wheel 150 may be fixed and the automated real-time alignment system may automatically adjust the skate blade 100 in the y-direction relative to the position of the grinding wheel 150.

In some embodiments, the automated real-time alignment system may perform the automatic adjustment at the beginning of the sharpening operation using one or more measurements captured during an alignment step. For example, the automated real-time alignment system may take measurements at one or more locations along the length of the skate blade 100 (e.g., using the distance measuring systems 1300) and the control system of the automated real-time alignment system can determine that desired y-position of the grinding wheel 150 relative to the skate blade 100 for each point measured along the skate blade 100. As such, the automated real-time alignment system can implement a dynamic multipoint adjustment for the grinding wheel 150 that occurs during the sharpening operation. For example, the automated real-time alignment system can determine the ideal path for the grinding wheel 150 as it travels along in the x-direction, with variations in the y-directions based on the measurements.

In some embodiments, the automated real-time alignment system may include one or more options to allow a user to perform a skate sharpening operation with the grinding wheel 150 positioned at different y-locations (also referred to as a grinding wheel offset) along the length of the skate blade 100. Sharpening the skate blade 100 in this manner will result in variations of the levelness of the skate blade 100 edges 116, 118 and may provide a performance advantage for the user of the skates. For example, a hockey player with different offsets at different locations may notice different performance compared to skate blades that have a consistent alignment or consistent offset along the length of the blade. The automated real-time alignment system can provide the users with the option of intentionally offsetting the centerline 152 of the grinding wheel 150 from the centerline 120 of the skate blade 100. This option may provide some performance advantage for some players based on the functional requirements of their position, such as, for example, a goalie in ice hockey. In some embodiments, a separate grinding wheel may be used in the skate sharpening system that will intentionally produce uneven edges 116, 118 when the grinding wheel 150 centerline 152 is lined up with the skate blade 100 central axis 120. In some cases, skaters, such as hockey goalies, may prefer that their skate blades 100 include an outside edge 118 that is less sharp than the inside edge 116. Currently, some ice hockey goalies manually dull the outside edges 118 of their skate blades 100 using manual methods, such as filing. A specialized griding wheel could be used to sharpen the skate blade 100 with a less sharp (e.g., larger radius of hollow 114) outside edge 118, without any further dulling required by the skater.

Another benefit provided by continuous monitoring may be that the height (the z-direction relative to an X-Y plane) of the skate blade 100 can also be measured and monitored. The height information may provide benefits to the sharpening process as well as other processes, such as, for example, profiling operations. The height information can be used to determine a desired stopping location for the grinding wheel 150 at one or both ends along the length of the blade 100. The stopping locations may be used, for example, to prevent the grinding wheel 150 from removing too much material at either end of the skate blade 100.

In some embodiments, the automated real-time alignment system may be controllable by a user device (e.g., the user device 1000) via wired (e.g., USB) or wireless (e.g., NFC, a wireless network, etc.) communication interfaces. The system may be configured to interface with the user device 1000 to perform a measurement via, for example, a related smart phone application (e.g., the sharpening application described above). The application may be used to automatically control the y-axis adjustment for the grinding wheel 150 in the sharpener 200.

In some embodiments, the control system of the automated real-time alignment system may include a deep learning algorithm, machine learning algorithm, and/or the like. The system may use the measurement data to continually improve the quality and speed of operations performed on the sharpener 200 (e.g., sharpening or profiling operations). The algorithm(s) may incorporate data associated with a profile of a skater.

In some embodiments, measurement data may be used by the automated real-time alignment system to improve the profiling process completed on a skate sharpening system. For example, the automated real-time alignment system may use distance measuring systems 1300 to map the profile of the blade. In some embodiments, the skate sharpening system 200 can include two or more encoders that can be used to map the profile of the skate blade. A first encoder can be used to record mapping data associated with the length of the skate blade 100 (e.g., during translation of the grinding wheel 150 in the x-direction). A second encoder can record mapping data associated with the height of the skate blade, (e.g., movement of the motor arm in the z-direction). This mapping data can be used to create a profile of the skate blade 100. The profile data can be used to verify and ensure that the profile of the blade 100 is maintained during the sharpening operation. This information can also be used by a skate sharpening system with profiling capabilities to modify the profile of the skate blade from one shape to another, such as, for example, by a closed loop feedback.

In some embodiments, one or more sensor(s) (e.g., of the distance measuring systems 1300) in the automated real-time alignment system may be used to determine blade thickness 122 of the skate blade 100. The thickness information may be useful in the processing of the blade 100. In some embodiments, the sensor(s) in the automated real-time alignment system may be used to determine the height and profile of the blade 100. The height and profile information may be useful in the processing of the blade 100.

In some embodiments, the sensor(s) used in the automated real-time alignment system and/or other systems described herein may be configured to measure one or more of: one side of a skate blade 100, both sides of the skate blade 100, the blade securing mechanism, fiducials on the blade securing mechanism (e.g., the jaws 202), the height of the blade 100 (e.g., if the one or more sensors are directed at the bottom of the blade 100), the radius of hollow 114 of the blade 100 (e.g., if the one or more sensors are directed at the bottom of the blade 100), the height of the blade's edges 116, 118, the remaining material on the blade 100 (e.g., to determine the blade life), a portion of the grinding wheel 150 (e.g., a face or side of the grinding wheel 150), the adjustment component, the grinding wheel arbor of the sharpener 200, and/or the like.

### E. Computer Systems

FIG. 12 is a block diagram depicting an operating environment for implementing for implementing one or more embodiments of the skate sharpening alignment systems and processes disclosed herein. The operating environment can include a skate sharpener 200, user computing devices 1210, a server computing system 1220, and measurement device 1240. The various components of the operating environment 1200 can be configured to communicate with each other over the network 1250.

Although only one network 1250 is illustrated, multiple distinct and/or distributed networks 108 may exist. The network 1250 can include any type of communication network. For example, the network 1250 can include one or more of a wide area network (WAN), a local area network (LAN), a cellular network, an ad hoc network, a satellite network, a wired network, a wireless network, a short-range communication network (e.g., NFC, Bluetooth, and the like) and so forth. The network 1250 can enable communication between the various computing devices 1210, skate sharpeners 200, measurements devices 1240, server computing system 1220, and/or other electronic devices.

The skate sharpening system 200 can include computing resources 204 for controlling operation of the hardware components 206. The computing resources can include a control system configured to control operation of the skate sharpener. The control system can include at least one processor and one or more controllers or microcontrollers. The controllers can provide lower-level control of corresponding hardware components within the skate sharpener, such as a grinding wheel motor, a carriage motor, and a fan. The sharpening system 200 can include a user interface (UI) display panel. The sharpening system 200 can include one or more communication interface(s) for communicating over the network 1250. The skate sharpener 200 may be configured to communicate over one or more networks, including, for example, a local area network (LAN), wide area network (WAN), and/or the Internet, for example, via a wired, wireless, or a combination of wired and wireless, communication links. The skate sharpener can be configured to communicate using short-range wireless communication technologies such as near field communication (NFC), Bluetooth, and/or the like. The skate sharpener 200 can utilize the communication interfaces to communicate with measurement devices 1240, user computing devices 1210, the server computing system 1220, and third party platforms (not shown), and/or additional computing devices.

The skate sharpener can include sensors and other components (e.g., switches) can also be connected to the control system. For example, sensors or switches can be used to detect whether a skate is properly positioned for sharpening, whether the door has been opened or is closed, whether a dust tray or filter member is properly positioned or the like. The information from these sensors and other components can be used to better control operations of the skate sharpener to provide improved performance or safer operation.

The controllers and processor are hardware computing devices including memory, I/O interface circuitry and instruction processing circuitry for executing computer program instructions stored in the memory. The controllers may be specialized for low-level real-time control tasks such as achieving and maintaining a commanded rotational speed for a motor. The processor may have a more generalized architecture and a set of programming resources to perform a of higher-level tasks, including interfacing to a user via a UI display panel. The processor can be configured to communicate with other computing devices over the network 1250 using one or more communication interfaces. The processor executing instructions of a particular computing module may perform functions defined by the program. For example, the processor executing instructions of a sharpening operation, an alignment operation, or other operations controller may be referred to as sharpening control circuitry, and the processor executing instructions related to usage control may be referred to as usage control circuitry. In some embodiments, the skate blade sharpening system may include a measurement device 1230, such as measurement devices 1300 and measurement device 400, as further described herein. The control system of the skate sharpener can be configured to communicate with and control operation of the measurement device 1230.

The user computing device 1210 may be any type of computing system, such as a desktop, laptop, wearable device (for example, smart watches and glasses with computing functionality), and wireless mobile devices (for example, smart phones, PDAs, tablets, or the like), to name a few. The example user computing device 1210 can be in communication with one or more the skate sharpeners 200, measurement devices 1220, user computing devices 1210, the server computing system 1220, and third party platforms (not shown), and/or additional computing devices via one or more networks 1250.

The user computing system 1210 includes one or more processing units (CPU), which may comprise a microprocessor. The computing resources further include physical memory, such as random-access memory (RAM) for temporary storage of information, a read only memory (ROM) for permanent storage of information, and a mass storage device, such as a backing store, hard drive, rotating magnetic disks, solid state disks (SSD), flash memory, phase-change memory (PCM), 3D XPoint memory, diskette, or optical media storage device. Typically, the components of the computer system 1210 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 1210 can include one or more input/output (I/O) devices and interfaces 1212, such as a keyboard, mouse, touch pad, and printer. The I/O devices and interfaces can include one or more display devices, such as a monitor, which allows the visual presentation of data to a user. More particularly, a display device provides for the presentation of GUIs as application software data, and multi-media presentations, for example. The I/O devices and interfaces can also provide a communications interface to various external devices. The computer system 1210 may comprise one or more multi-media devices, such as speakers, video cards, graphics accelerators, and microphones, for example.

The user computing device 1210 can comprise one or more programming modules, such as a sharpener module 1214 that carries out the functions, methods, acts, and/or processes described herein. The sharpener module 1214 is executed on the computer system 1210 by computing resources 1212, such as a central processing unit. The sharpener module 1214 can be an application installed on the user computing device, such as an “app” on a smartphone.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The server computing system 1220 can include one or more application host systems 1224 and data source(s) 1222. The server computing system 1220 may include one or more computing systems configured to execute a portion of the game application 110. In some embodiments, the one or more application host systems 122 can include one or more computing devices, such as servers and databases that may host and/or execute a portion of one or more instances of the sharpener module 1214. In certain embodiments, instead of or in addition to executing a portion of the sharpener module 1214, the application host systems 1224 may execute another application, which may complement and/or interact with the sharpener module 1214 during execution of an instance of the sharpener module 1214 by the user computing device 1210. The application host system 1224 may further be configured to interface with the measurement device 1240 and the skate sharpener 200. For example, the application host systems 1224 may be configured to control operation of the skate sharpener 200 based on the output of the measurement device 1240. In some embodiments, the user computing device 1210 may use the sharpener module 1214 to communicate with the skate sharpener 200 via the application host system 1224.

The server computing system 1220 may run on a variety of computing devices, such as a server, a Windows server, a Structure Query Language server, a Unix Server, a personal computer, a laptop computer, a smart phone, a personal digital assistant, a tablet, and so forth. Servers may include a variety of servers such as database servers (for example, Oracle, DB2, Informix, Microsoft SQL Server, MySQL, or Ingres), application servers, data loader servers, or web servers. In addition, the servers may run a variety of software for data visualization, distributed file systems, distributed processing, web portals, enterprise workflow, form management, and so forth. In other embodiments, the server computing system 1220 may run on a cluster computer system, a mainframe computer system and/or other computing system suitable for controlling and/or communicating with large databases, performing high volume transaction processing, and generating reports from large databases. The computing system 1202 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

Access to the programming module 1214 of the computer system 1202 by computing systems 1220 and/or by data sources 1222 may be through a web-enabled user access point such as the computing systems' 1220 or data source's 1222 personal computer, cellular phone, smartphone, laptop, tablet computer, e-reader device, audio player, or another device capable of connecting to the network 1218. Such a device may have a browser module that is implemented as a module that uses text, graphics, audio, video, and other media to present data and to allow interaction with data via the network 1218.

The server computing system 1220 may include one or more internal and/or external data sources (for example, data sources 1222). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Caché), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MogoDB Atlas, Amazon Aurora, Amazon DynamoDB, Amazon Redshift, Amazon ElastiCache, Amazon MemoryDB for Redis, Amazon DocumentDB, Amazon Keyspaces, Amazon EKS, Amazon Neptune, Amazon Timestream, or Amazon QLDB), a non-relational database, or a record-based database.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL ca specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

### EXAMPLES

Various example embodiments of the disclosure can be described by the following clauses:

Clause 1. An alignment system configured for use in a skate sharpening system comprising: a securing component configured to secure a skate blade within a skate sharpening system; an alignment component positioned within a housing of the skate sharpening system; a control system configured to control operation of the skate sharpening system; and at least one measurement device configured to perform at least one measurement of at least one of component of the skate sharpening system.

Clause 2. The alignment system of clause 1, further comprising one or more actuators configured to move the alignment component, wherein the control system is configured to control the one or more actuators.

Clause 3. The alignment system of any of clauses 1-2, wherein the one or more actuators comprise: one or more motors or one or more piezoelectric actuators.

Clause 4. The alignment system of any of clauses 1-3, wherein the at least one measurement device is configured to measure a position of the securing component of the skate sharpening system.

Clause 5. The alignment system of any of clauses 1-4, wherein the at least one measurement device is configured to measure a location of an object in the securing component of the skate sharpening system.

Clause 6. The alignment system of clause 5, wherein the object is a skate blade.

Clause 7. The alignment system of clause 6, wherein a center location of the skate blade is determined by identifying a midplane between two faces of the skate blade.

Clause 8. The alignment system of clause 6, wherein a center location of the skate blade is determined by measuring the location of a first skate blade edge and a second skate blade edge.

Clause 9. The alignment system of any of clauses 1-8, wherein the alignment component is a calibration wheel.

Clause 10. The alignment system of any of clauses 1-9, wherein the alignment component is a grinding ring.

Clause 11. The alignment system of any of clauses 1-10, wherein the at least one measurement device is positioned in the securing component of the skate sharpening system.

Clause 12. The alignment system of any of clauses 1-11, wherein the skate sharpening system comprises and arbor, and the alignment component is coupled to the arbor.

Clause 13. The alignment system of clause 12, wherein the at least one measurement device is configured to measure a position of the arbor.

Clause 14. The alignment system of clause 12, wherein the at least one measurement device is configured to measure a position of the alignment component on the arbor.

Clause 15. The alignment system of clause 14, wherein the at least one measurement device is configured to measure a center location of the alignment component on the arbor.

Clause 16. The alignment system of clause 15, wherein the center location of the grinding wheel is determined by identifying a midplane between two faces of the grinding wheel.

Clause 17. The alignment system of clause 15, wherein the center location of the grinding wheel is determined by identifying a midplane based on at a position of at least one face of the grinding wheel.

Clause 18. The alignment system of any of clauses 1-17, wherein the at least one measurement device is calibrated by positioning an alignment component at a known location in a defined coordinate system.

Clause 19. The alignment system of any of clauses 1-18, wherein the at least one measurement device includes one or more: lasers, position sensitive detectors, charge-couple devices, optical position sensors, and/or complementary metal oxide semiconductor photodetectors.

Clause 20. The alignment system of any of clauses 1-19, wherein the one or more actuators is coupled to an encoder, wherein the encoder provides feedback data to the control system.

Clause 21. The alignment system of any of clauses 1-20, wherein the arbor is coupled to an encoder, wherein the encoder provides feedback data to the control system.

Clause 22. The alignment system of any of clauses 1-21 wherein the alignment component is coupled to an encoder, wherein the encoder provides feedback data to the control system.

Clause 23. The alignment system of any of clauses 20-22, wherein the encoder is an optical encoder or a magnetic encoder.

Clause 24. The alignment system of any of clauses 1-23, wherein the control system is configured to automatically adjust a position of the alignment component or the position of the securing component.

Clause 25. The alignment system of clause 24, wherein the automatic adjustment aligns a center location of the alignment component with a center location of a skate blade prior to a skate sharpening operation.

Clause 26. The alignment system of clause 24, wherein the automatic adjustment aligns a center location of the alignment component with a center location of a skate blade prior to a skate profiling operation.

Clause 27. The alignment system of clause 24, wherein the automatic adjustment aligns a center location of the grinding wheel with a center location of a skate blade, as determined by the at least one measurement device, continuously during a skate sharpening operation.

Clause 28. The alignment system of clause 24, wherein the automatic adjustment aligns a center location of a grinding wheel with a center location of a skate blade, as determined by the at least one measurement device, continuously during a skate profiling operation.

Clause 29. The alignment system of any of clauses 1-28, wherein the at least one measurement device is configured to determine a real-time center location of a skate blade during a skate sharpening operation.

Clause 30. The alignment system of any of clauses 1-29, wherein the at least one measurement device is configured to determine a real-time center location of a grinding wheel during a skate sharpening operation.

Clause 31. The alignment system of any of clauses 1-30, wherein the at least one measurement device is configured to determine a real-time center location of a skate blade during a skate profiling operation.

Clause 32. The alignment system of any of clauses 1-31, wherein the at least one measurement device is configured to determine a real-time center location of a grinding wheel during a skate profiling operation.

Clause 33. Then alignment system of any of clauses 1-32, wherein the at least one measurement device is further configured to determine a first end point and a second end point on a skate blade.

Clause 34. The alignment system of clause 33, wherein control system uses a height of the grinding wheel to determine a first end point and a second end point on a skate blade, wherein the height is along a z-axis of the skate sharpening system.

Clause 35. The alignment system of clause 33, wherein the grinding wheel moves between the first and second end points during a skate sharpening operation.

Clause 36. The alignment system of clause 33, wherein the grinding wheel moves between the first and second end points during a skate profiling operation.

Clause 37. The alignment system of any of clauses 1-36, wherein the at least one measurement device is configured to determine a center location of a skate blade during a sharpening operation, wherein the control system is configured to automatically position a center location of the grinding wheel relative to the center location of the skate blade during the sharpening operation.

Clause 38. The alignment system of clause 37, wherein the center location of the grinding wheel is offset relative to the center location of the skate blade.

Clause 39. The alignment system of any of clauses 37-38, wherein the control system is configured to continuously determine the center location of the skate blade during the sharpening operation, and continuously position the center location of the grinding wheel relative to the center location of the skate blade during the sharpening operation.

Clause 40. The alignment system of any of clauses 1-39, wherein the at least one measurement device includes a laser source and a position sensitive detector.

Clause 41. The alignment system of any of clauses 1-40, wherein the at least one measurement device includes a laser source and a complementary metal oxide semiconductor image sensor.

Clause 42. The alignment system of any of clauses 1-41, wherein the at least one measurement device includes a laser source and a photodiode image sensor.

Clause 43. The alignment system of any of clauses 1-42, wherein the at least one measurement device includes an inductive proximity sensor, a capacity proximity second, or an IR proximity sensor.

Clause 44. The alignment system of any of clauses 1-43, wherein the at least one measurement device includes an ultrasonic proximity sensor.

Clause 45. The alignment system of any of clauses 1-44, wherein the at least one measurement device includes a LiDAR proximity sensor.

Clause 46. The alignment system of any of clauses 1-45, wherein the at least one measurement device includes multiple complementary metal oxide semiconductors or charge-couple devices for stereo vision distance detection.

Clause 47. The alignment system of any of clauses 1-46, wherein the at least one measurement device includes a mechanical indicator.

Clause 48. The alignment system of any of clauses 1-47, wherein the at least one measurement device includes a vision imaging system configured to generate at least one image, wherein the vision imaging system is configured to process the at least one image to determine a center location of the skate blade before and/or during a sharpening process, wherein the control system is configured to automatically align a center location of a grinding wheel relative to the center location of the skate blade before and/or during the sharpening operation.

Clause 49. The alignment system of any of clauses 1-48 further comprising a lens and/or other optical components configured for focusing, collimating, and polarizing.

Clause 50. The alignment system of any of clauses 1-49, wherein the at least one measurement device is further configured to determine a width of a skate blade, wherein the at least one measurement device is configured to determine a center location of a skate blade based at least in part on the width.

Clause 51. The alignment system of any of clauses 1-50, wherein the at least one measurement device is configured to measure a profile of a skate blade.

Clause 52. The alignment system of any of clauses 1-51, wherein the at least one measurement device is configured to measure fiducials in a clamp apparatus of a skate blade in order to determine a center location of the skate blade.

Clause 53. The alignment system of any of clauses 1-52, wherein the control system is configured to use one or more deep learning algorithms during operation, wherein the deep learning algorithms are configured to be updated based on operational data.

Clause 54. The alignment system of clause 53, wherein the deep learning algorithms are configured to use profile information associated with a user profile of a skater.

Clause 55. The alignment system of any of clauses 1-54, wherein control system is configured to determine an amount of skate blade material removed during each pass of a sharpening operation.

Clause 56. The alignment system of any of clauses 1-55, wherein the control system is configured to sharpen skate blades during a sharpening operation with a defined offset between a center location of a skate blade and a center location of a grinding wheel.

Clause 57. The alignment system of clause 56, wherein the offset may vary along a length of the skate blade.

Clause 58. The alignment system of any of clauses 1-57, wherein the control system is configured to output instructions to manipulate the alignment component based on the at least one measurement.

Clause 59. The alignment system of clause 58, wherein the alignment system is configured to output the instructions to a display on the skate sharpening system.

Clause 60. The alignment system of clause 58, wherein the control system is configured to communicate with a remote computing device, and output the instructions to a display on a remote computing device.

Clause 61. The alignment system of clause 52, wherein the alignment component is configured to be moved by a user.

Clause 62. A method for operating a skate sharpening system comprising: determining, by a control system of the skate sharpening system, a center location of a skate blade in a skate sharpening system using at least one measurement device; determining, by the control system, a center location of a grinding wheel in a skate sharpening system using the at least one measurement device; and generating, by the control system, instructions to align the center location of the skate blade with the center location of the grinding wheel.

Clause 63. The method of clause 62 further comprising automatically aligning the center location of the skate blade and the center location of the grinding wheel based on the instructions.

Clause 64. The method of clause 63, wherein automatically aligning the center location of the skate blade and the center location of the grinding wheel is performed prior to a skate sharpening operation.

Clause 65. The method of clause 63, wherein automatically aligning the center location of the skate blade and the center location of the grinding wheel is performed continuously during a skate sharpening operation.

Clause 66. The method of clause 63, outputting the instructions to a remote computing device, wherein the remote computing device is configured to output alignment instructions on a display based on the instructions.

Clause 67. The method of clause 63, outputting alignment instructions on a display of the skate sharpening system based on the instructions.

Clause 68. The method of any of clauses 66-67, wherein the alignment instructions provide manual adjustments to the skate sharpening system for a user to manually align the center location of the skate blade with the center location of the grinding wheel.

Clause 69. A measurement device comprising: a frame configured to couple to a securing component of a skate sharpening system; a measurement system configured to obtain measurement data associated with at least one component of the skate sharpening system; a control system with computer-executable instructions configured to, when executed: determine at least one measurement of the at least one component of the skate sharpening system, and generate an output based at least in part on the at least one measurement.

Clause 70. The measurement device of clause 69, wherein the control system is further configured to output instructions to display the output on a screen of the measurement device.

Clause 71. The measurement device of any of clauses 69-70, wherein the control system is further configured to transmit instructions to display the output on a remote computing device.

Clause 72. The measurement device of any of clauses 69-71, wherein the control system is further configured to transmit instructions to display the output on the skate sharpening system.

Clause 73. The measurement device of any of clauses 69-72, wherein the output comprises human-readable instructions for a user to adjust at least one component of the skate sharpening system.

Clause 74. The measurement device of any of clauses 69-73, wherein the computer-executable instructions are further configured to transmit instructions for adjusting one or more components of the skate sharpening system, the instructions determined based on the at least one measurement.

Clause 75. The measurement device of any of clauses 69-74, wherein the instructions for adjusting the one or more components of the skate sharpening system are machine-readable instructions for the skate sharpening system to automatically adjust at least one component of the skate sharpening system.

Clause 76. The measurement device of any of clauses 69-75, wherein the instructions are human-readable instructions for a user to adjust at least one component of the skate sharpening system.

Clause 77. The measurement device of any of clauses 69-76, wherein the instructions include modifications to a position of a grinding wheel of the skate sharpening system.

Clause 78. The measurement device of clause 77, wherein the measurement device is configured to be removably coupled to the skate sharpening system.

Clause 79. The measurement device of clause 78, wherein the one or more measurements comprise the position of a target relative to a first axis of the skate sharpening system.

Clause 80. The measurement device of any of clauses 69-79, wherein the target comprises a calibration wheel.

Clause 81. The measurement device of clause 80, wherein the calibration wheel comprises a reflective outer surface.

Clause 82. The measurement device of clause 81, where the reflective outer surface of the calibration wheel includes at least a radius portion, the curve of the radius portion extending about a second axis, the second axis perpendicular to the first axis.

Clause 83. The measurement device of clause 79, wherein the target comprises a grinding wheel.

Clause 84. The measurement device of clause 83, wherein the grinding wheel is coupled to an arbor.

Clause 85. The measurement device of any of clauses 69-84, wherein the measurement system further comprises a light emitting source and a sensor.

Clause 86. The measurement device of clause 85, wherein the light emitting source comprises a laser.

Clause 87. The measurement device of clause 86, wherein the laser is configured to direct a laser beam towards a reflective surface of the target.

Clause 88. The measurement device of clause 87, wherein the sensor is configured to receive a reflected laser beam from target.

Clause 89. The measurement device of clause 88, wherein the at least one measurement associated with the position of the target along the first axis are determined based on a location of the reflected laser beam on the sensor.

Clause 90. The measurement device of clause 89, wherein the measurement system further comprises one or more of a filter and a lens, wherein the filter is configured to filter at least the laser beam and the lens is configured to receive the reflected laser beam.

Clause 91. The measurement device of clause 90, wherein the at least one measurement comprises an angle between an axis of the reflected laser beam and a central axis of the sensor.

Clause 92. The measurement device of any of clauses 69-91, further comprising an external housing, the frame positioned at least partially within the external housing.

Clause 93. The measurement device of clause 91, wherein the external housing comprises a plurality of resilient members extending into the frame, wherein the resilient members are configured to allow the frame to move relatively to the external housing.

Clause 94. The measurement device of any of clauses 69-93, wherein the frame further comprises a laser aperture, the laser aperture configured to limit a size of the laser beam.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

Additionally, features described in connection with one embodiment can be incorporated into another of the disclosed embodiments, even if not expressly discussed herein, and embodiments having the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements and features referred to or indicated in the description of the application, individually or collectively, in any or all combinations of two or more of said parts, elements or features.

Where, in the foregoing description, reference has been made to integers or components having known equivalents thereof, those integers are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. The following lists have example embodiments that are within the scope of this disclosure. The example embodiments that are listed should in no way be interpreted as limiting the scope of the embodiments. Various features of the example embodiments that are listed can be removed, added, or combined to form additional embodiments, which are part of this disclosure:

1. An alignment system configured for use in a skate sharpening system comprising:
a securing component configured to secure a skate blade within a skate sharpening system;
an alignment component positioned within a housing of the skate sharpening system;
a control system configured to control operation of the skate sharpening system; and
at least one measurement device configured to perform at least one measurement of at least one of component of the skate sharpening system, the at least one measurement device including one or more: lasers, position sensitive detectors, charge-couple devices, optical position sensors, or complementary metal oxide semiconductor photodetectors.

2-4. (canceled)

5. The alignment system of claim 1, wherein the at least one measurement device is configured to measure a location of an object in the securing component of the skate sharpening system.

6-61. (canceled)

62. A method for operating a skate sharpening system comprising:
determining, by a control system of the skate sharpening system, a center location of a skate blade in a skate sharpening system using at least one measurement device;
determining, by the control system, a center location of a grinding wheel in a skate sharpening system using the at least one measurement device; and
generating, by the control system, instructions to align the center location of the skate blade with the center location of the grinding wheel.

63. The method of claim 62 further comprising automatically aligning the center location of the skate blade and the center location of the grinding wheel based on the instructions.

64. The method of claim 63, wherein automatically aligning the center location of the skate blade and the center location of the grinding wheel is performed prior to a skate sharpening operation.

65. The method of claim 63, wherein automatically aligning the center location of the skate blade and the center location of the grinding wheel is performed continuously during a skate sharpening operation.

66. The method of claim 63, outputting the instructions to a remote computing device, wherein the remote computing device is configured to output alignment instructions on a display based on the instructions.

67. The method of claim 63, outputting alignment instructions on a display of the skate sharpening system based on the instructions.

68. The method of claim 66, wherein the alignment instructions provide manual adjustments to the skate sharpening system for a user to manually align the center location of the skate blade with the center location of the grinding wheel.

69. A measurement device comprising:
a frame configured to couple to a securing component of a skate sharpening system;
a measurement system configured to obtain measurement data associated with at least one component of the skate sharpening system; and
a control system with computer-executable instructions configured to, when executed:
determine at least one measurement of the at least one component of the skate sharpening system, and
generate an output based at least in part on the at least one measurement.

70-72. (canceled)

73. The measurement device of claim 69, wherein the output comprises human-readable instructions for a user to adjust at least one component of the skate sharpening system.

74. (canceled)

75. The measurement device of claim 69, wherein the computer-executable instructions are further configured to transmit instructions for adjusting one or more components of the skate sharpening system, the instructions for adjusting the one or more components of the skate sharpening system being machine-readable instructions for the skate sharpening system to automatically adjust at least one component of the skate sharpening system.

76-78. (canceled)

79. The measurement device of claim 69, wherein the at least one measurement comprises a position of a target relative to a first axis of the skate sharpening system.

80. The measurement device of claim 79, wherein the target comprises a calibration wheel.

81. The measurement device of claim 80, wherein the calibration wheel comprises a reflective outer surface.

82. The measurement device of claim 81, where the reflective outer surface of the calibration wheel includes at least a radius portion, a curve of the radius portion extending about a second axis, the second axis perpendicular to the first axis.

83. The measurement device of claim 79, wherein the target comprises a grinding wheel.

84. (canceled)

85. The measurement device of claim 69, wherein the measurement system further comprises a light emitting source and a sensor.

86-91. (canceled)

92. The measurement device of claim 69, further comprising an external housing, the frame positioned at least partially within the external housing.

93. The measurement device of claim 92, wherein the external housing comprises a plurality of resilient members extending into the frame, wherein the plurality of resilient members are configured to allow the frame to move relatively to the external housing.

94. (canceled)
